(19) United States
(12) Patent Application Publication
(10) Pub. No.: US 2014/0220450 A1
(43) Pub. Date: Aug. 7, 2014

(54) NON-AQUEOUS ELECTROLYTE FOR RECHARGEABLE MAGNESIUM ION CELL

(71) Applicants: Robert E. Jilek, Belmont, MA (US); David Eaglesham, Lexington, MA (US); Robert Ellis Doe, Norwood, MA (US); Andrew Gmitter, Cambridge, MA (US)

(72) Inventors: Robert E. Jilek, Belmont, MA (US); David Eaglesham, Lexington, MA (US); Robert Ellis Doe, Norwood, MA (US); Andrew Gmitter, Cambridge, MA (US)

(73) Assignee: PELLION TECHNOLOGIES, INC., Cambridge, MA (US)

(21) Appl. No.: 14/143,898

(22) Filed: Dec. 30, 2013

Related U.S. Application Data
(63) Continuation-in-part of application No. PCT/US2012/071350, filed on Dec. 21, 2012.
Application No. PCT/US2012/071350 is a continuation-in-part of application No. 13/803,456, filed on Mar. 14, 2013.
(60) Provisional application No. 61/579,244, filed on Dec. 22, 2011.
(60) Provisional application No. 61/613,063, filed on Mar. 20, 2012.

(51) Int. Cl. H01M 10/0568; H01M 10/0565; H01M 10/054

(52) U.S. Cl. CPC H01M 10/0568; H01M 10/054; H01M 10/0565; H01M 2300/0025
USPC 429/300; 429/188; 429/199

(57) ABSTRACT

An electrolyte for use in electrochemical cells is provided. One type of non-aqueous Magnesium electrolyte comprises: at least one organic solvent; at least one electrolytically active, soluble, inorganic Magnesium salt complex represented by the formula: MgₙZX_{3+(2*n)}, in which Z is selected from a group consisting of aluminum, boron, phosphorus, titanium, iron, and antimony; X is a halogen and n=1-5. The properties of the electrolyte include high conductivity, high Coulombic efficiency, and an electrochemical window that can exceed 3.5 V vs. Mg/Mg⁺² and total water content of <200 ppm. The use of this electrolyte promotes the electrochemical deposition and dissolution of Mg from the negative electrode without the use of any additive. Other Mg-containing electrolyte systems that are expected to be suitable for use in secondary batteries are also described. Rechargeable, high energy density Magnesium cells containing a cathode, an Mg metal anode, and an electrolyte are also disclosed.

### CROSS-REFERENCE TO RELATED APPLICATIONS

This application is a continuation-in-part of and claims priority to and the benefit of co-pending International Patent Application No. PCT/US2012/71350 filed Dec. 21, 2012 which application claimed the benefit and priority of U.S. provisional patent application Ser. No. 61/579,244 filed Dec. 22, 2011, and is a continuation-in-part of and claims priority to and the benefit of co-pending U.S. patent application Ser. No. 13/803,456 filed Mar. 14, 2013 which application claimed the benefit and priority of U.S. provisional patent application Ser. No. 61/613,063 filed Mar. 20, 2012, each of which applications is incorporated herein by reference in its entirety for all purposes.

### FIELD OF THE INVENTION

The present invention relates to an electrolytic solution wherein Mg-ions are the charge carrier. The invention further relates to electrochemical cells utilizing this non-aqueous liquid electrolyte with a cathode and a magnesium-based anode. The invention relates to electrolytic solutions in general and particularly to an electrolyte that comprises magnesium ions as the charge carrier.

### BACKGROUND

A variety of rechargeable, high energy density electrochemical cells have been demonstrated although the most widely utilized commercial system is that based upon Li-ion chemistry because it displays very high energy density. Such cells usually include a transition metal oxide or chalcogenide cathode-active material, an anode-active lithium metal or lithium intercalation or alloy compound such as graphitic carbon, tin and silicon, and an electrolytic solution containing a dissolved lithium-based salt in an aprotic organic or inorganic solvent or in a polymer. Today there is great demand for energy storage devices capable of storing more energy per unit volume or per unit mass, e.g., Watt-hours per liter (Wh/l) or Watt-hours per kilogram (Wh/kg), than premier rechargeable Li-ion batteries are capable of delivering. Consequently an increasingly sought after route to meeting this demand higher energy density is to replace the monovalent cation lithium (Li⁺) with divalent magnesium cations (Mg²⁺) because magnesium can enable nearly twice the charge of Li⁺ to be transferred, per volume. Electrolytes utilizing an alkali metal with organic ligands from organometallic species have been described. Generally the use of an alkaline earth metal anode such as magnesium would appear disadvantageous relative to the use of an alkali metal such as lithium because alkali metal anodes are much more readily ionized than are alkaline earth metal anodes. In addition, on recharge the cell should be capable of re-depositing the anode metal that was dissolved during discharge, in a relatively pure state, and without the formation of deposits that block the electrodes. One practiced in the art would note this characteristic is not natural for Mg. Despite this, there are numerous other disadvantages to alkali batteries. Alkali metals, and lithium in particular, are expensive and highly reactive. Alkali metals are also highly flammable, and fire caused by the reaction of alkali metals with oxygen, water or other reactive materials is extremely difficult to extinguish. As a result, the use of alkali metals requires specialized facilities, such as dry rooms, specialized equipment and specialized procedures, and shipment of Lithium containing products (e.g., batteries) is tightly controlled. In contrast, magnesium metal and its respective inorganic salts are easy to process and usually are considered as benign. Magnesium metal is reactive, but it undergoes rapid passivation of the surface, such that the metal and its alloys are highly stable. Magnesium is inexpensive relative to the alkali metals, and widely used as ubiquitous construction materials.

Known electrolytes that enable reversible, electrochemical deposition of Mg and that have potential use in a battery contain organometallic materials. Most often these electrolytes contain organometallic Grignard salts as the electrochemically active component. However sustaining anodic limits greater than 1 Volt is problematic or impossible with the usual intercalation cathodes because of electrolyte decomposition and corresponding encrustation and/or passivation of electrode surfaces. The anodic limit, or anodic voltage, is a measure of an electrolytes stability limit; represented as the highest voltage that can be applied to the electrolyte prior to initiating oxidative decomposition of the electrolyte at an electrode surface. Enhanced electrochemical stability has been demonstrated by complexing Grignard reagents with strong Lewis acids. For example, a cell comprised of a magnesium metal anode, a molybdenum sulfide “Chevrel” phase active material cathode, and an electrolyte solution derived from an organometallic complex containing Mg is capable of the reversible, electrochemical plating of magnesium metal from solutions with about a 2 V anodic limit of the stability window. Under the same principle similar results have also been shown when Magnesium Chloride and organometallic Aluminum compounds complexes are employed.

Such cells are low energy density due to a low difference in operating potentials between a Chevrel cathode and Mg metal anode and therefore are not commercially viable cells. Sustaining an anodic voltage greater than 2 volts is problematic or impossible with the usual intercalation cathodes and electrolytes based upon Grignard reagents and other organometallic species. Magnesium batteries operating at voltages greater than 1.5 volts are particularly prone to electrolyte decomposition and to encrustation and/or passivation of the electrode surface due to anodic limits of the electrolyte. Furthermore electrolytes intended for use in electrochemical cells in which the plating and stripping of Mg ions is required include organometallic species among the ionic species in the respective electrolytic solutions. There are many disadvantages to organometallic species, relative to inorganic salts. Practically, all organometallic species of the alkalis and the earth alkalis are highly unstable in the presence of air and water and thus are classified as pyrophoric. Organometallic species of sufficient purity are quite expensive to produce. Organometallic species introduce organic ligands into the electrolytic solution, which will limit the chemical stability of the solution when in contact with certain electrode active materials and other electrochemical cell components. In general, handling, manipulation and storing organometallic species of this sort are complicated, hazardous and expensive.

In contrast one practiced in the art will recognize that previous attempts to utilize inorganic magnesium salts failed to enable substantial reversibility of magnesium deposition with high Coulombic efficiency and low overpotential. In general it has been shown that electrodeposition in previous inorganic magnesium salt solutions corresponded with electrolyte consumption and resulted in decomposition of the solution components. The decomposition products passivate the electrode blocking in further electrochemical reaction. Consequently no commercial Mg secondary batteries have succeeded thus far.

The literature on Mg secondary batteries includes N. Amir et al., “Progress in nonaqueous magnesium electrochemistry,” Journal of Power Sources 174 (2007) 1234-1240, published on line on Jun. 30, 2007; Y Gofer et al., “Magnesium Batteries (Secondary and Primary),” published in Encyclopedia of Electrochemical Power Sources 2009 285-301 Elsevier B.V.; and John Muldoon et al., “Electrolyte roadblocks to a magnesium rechargeable battery,” 5 (2012) Energy & Environmental Science 5941-5950.

Also previously described is Aurbach et al. in U.S. Pat. No. 6,316,141, issued Nov. 13, 2001, which is said to disclose a cell comprised of a Magnesium metal anode, a Molybdenum Sulfide “Chevrel” phase active material cathode, and an electrolyte solution derived from an organometallic complex containing Mg. The critical aspect of that invention is the specification of an electrolyte capable of the reversible, electrochemical plating of Magnesium metal from solutions with a 2 V anodic limit. This was demonstrated through the formation of complex electrolytically active salts represented by the formula: M′^{+m}(ZRₙX_{q}−n)m in which: M′ is selected from a group consisting of magnesium, calcium, aluminum, lithium and sodium; Z is selected from a group consisting of aluminum, boron, phosphorus, antimony and arsenic; R represents radicals selected from the following groups: alkyl, alkenyl, aryl, phenyl, benzyl, and amido; X is a halogen (I, Br, Cl, F); m=1-3; and n=0-5 and q=6 in the case of Z=phosphorus, antimony and arsenic, and n=0-3 and q=4 in the case of Z=aluminum and boron.

In a different report Nakayama et. al., U.S. Patent Application Publication No. 2010/0136439, published Jun. 3, 2010, which is said to disclose a magnesium ion-containing nonaqueous electrolytic solution comprising a magnesium ion and another kind of a metal ion dissolved in an organic solvent, wherein solutions may be obtained through combinations of inorganic Lewis Base MgCl₂ and organometallic Aluminum Lewis Acids such as dimethylaluminum chloride or methylaluminum dichloride.

Also described is Yamamoto et al., U.S. Patent Application Publication No. 2009/0068568, published Mar. 12, 2009, which is said to disclose a magnesium ion containing non-aqueous electrolyte in which magnesium ions and aluminum ions are dissolved in an organic ethereal solvent, and which is formed by adding metal magnesium, a halogenated hydrocarbon, an aluminum halide AlY₃, and a quaternary ammonium salt to an organic ethereal solvent and applying a heating treatment while stirring them as a one-step reaction to form the Grignard-based organometallic containing complex solution species.

A highly sought attribute of Mg-ion batteries system is the utilization of a negative electrode capable of electrodeposition and stripping of an Mg-ion. This type of anode will provide a large fraction of the battery's overall energy density (as compare to the cathode) because Mg metal possesses both high gravimetric (2200 mAh/g) and volumentric (3880 mAh/l) energy. Achieving a high degree of reversible electrodeposition requires a non-aqueous electrolyte composed of materials similar to those utilized in Li-ion batteries. For example a high degree of reversible metal electrodeposition can occur with electrolytic solutions of organometallic Mg salts or Li salts. In addition, both Li-ion and Mg-ion electrolytes require an organic solvent(s) such as ether or ester that is stable over a broad potential window. In contrast, an electrolyte solution based upon an aqueous solvent is incapable of enabling highly reversible reactions near the plating potential of Li (−3.0401 V vs. SHE) and Mg (−2.372 V vs. SHE) metal because these voltages lie below the reduction potential of water (−0.8277 V vs. SHE).

Table 1 presented below summarizes observations regarding battery water content data in Li-ion batteries presented in the literature that have become known to the inventors of the present application. Much of the Li-ion literature demonstrates that incorporation of too much water in the electrolyte will result in several deleterious effects including, but not limited to, hydrogen fluoride formation, which corrodes cell materials (NP1), hydrogen gas formation, which creates internal pressure (NP2, NP3), and a less stable electrode-electrolyte interface (NP4). In addition, Yamaki et. al. (NP5) show that Coulombic efficiency decreases for low potential (i.e., anode) cycling processes. They note a marked improvement in Coulombic efficiency when decreasing water from 370 to 117 ppm and only a marginal improvement thereafter decreasing water content to 27 ppm. A substantial portion of Li-ion literature also shows that some water is necessary and beneficial to battery operation. For example, Maier et. al. (NP6) indicate that small amounts of water can hydrate the electroactive material, modifying it so as to facilitate Li-ion mobility. In another example, Xu and Jow (NP7) observe that water content as high as 620 ppm negligibly affects cycling performance of the cells while Aurbach (NP8) indicates electrolyte solutions containing 700 ppm cycle better than the dry counterpart.

In general, the Li-ion literature suggests a range of more than zero and less than several hundred to several thousand ppm of water is necessary and tolerable for optimal Li-ion cell operation. In one example, PL1 describes for Li-ion battery that “a trace of water may be present as an impurity in the electrolyte as well as in the positive and negative electrodes. Prior to battery fabrication, a small amount of water in range of tens of ppm is present in the electrolyte. This amount is small enough to cause no serious problems. However, after battery fabrication, hundreds of ppm of water present in the electrodes may be added to water already in the electrolyte. That is, the amount of water in the electrolyte is significantly increased.” In another example, PL2, suggests that water content as low as 50 ppm or less is desirable and that 30 ppm or less may be preferable. However it is notable that unrelated filings (PL3, PL4) both claim that less than or equal to 10,000 ppm of water is tolerable in a Li-ion cell while PL5 specifies a non-aqueous electrolyte, containing only small quantities of water; less than about 500 ppm depending upon the electrolyte salt being used. In yet two other examples, PL6 and PL7, it is reported that the solvent alone can contain up to only 1,000 ppm of water although the latter document indicates that it is preferably less than 100 ppm if possible. In another example, PL8 claims a battery with an electrolyte solution containing 200 to 500 ppm of water in the electrolyte while PL9 claims an electrolyte solution water content of not more than 400 ppm and PL10 claims 30 to 800 ppm water content. Collectively, the Li-ion literature indicates that it is necessary to have more than zero and less than several hundred to several thousand ppm of water in the non-aqueous electrolyte, and that can be considered substantially free of water. That is, the Li-ion literature teaches that a commercial rechargeable Li-ion battery will provide optimal cycling performance if the electrolyte solution contains more than zero and less than several hundred to several thousand ppm of water.

As stated previously the development of a commercial Mg-ion battery is a relatively nascent field as compared to Li-ion batteries. The chemistry of Mg-ion batteries is known to differ from the chemistry of Li-ion batteries in many regards. However several notable efforts have been undertaken to provide insight into the role and quantity of water that is beneficial or deleterious to cell operation in Mg-ion batteries. Table 2 presented below summarizes observations regarding battery water content data in Mg-ion batteries presented in the literature that have become known to the inventors of the present application. In one example PL11 claims a non-aqueous primary battery with an Mg anode and an electrolyte comprising both 0.5 to 4 weight percent LiPF₆ salt additive and a magnesium salt (i.e., magnesium perchlorate) dissolved in acetonitrile wherein the water content of the electrolyte is less than about 100 to 200 ppm. In one quality review of pure Magnesium electrolytes (i.e., those that are Lithium free, or more generally additive free), NP9, the authors assert that some Mg salts such as magnesium perchlorate are insoluble in dry solvents (e.g., THF containing about 70 ppm water), but that solubility is increased with the addition of water and that water molecules present facilitate Mg²⁺ insertion into oxides. However they also note that as little as 1% water, or 10,000 ppm, in the non-aqueous electrolyte will significantly increase the Mg anode overpotential. Like the Li-ion literature, the body of study on Mg batteries indicates that water may facilitate some performance aspects and be deleterious to others and as a whole teaches that several hundred to a several thousand ppm of water can enable optimal cycling performance. The similar range of water requirements previously described for Li and Mg electrolytes is interesting because one practiced in the art would note that Li metal will provide significantly (0.7 V) higher driving force towards the reduction of water than Magnesium metal. As such it would be expected that a given quantity of water in an electrochemical cell will be more harmful to the Li-ion performance than the Mg-ion performance.

TABLE 1
Summarizing Battery Water Content Data in Li-Ion Batteries

| | | Acceptable | | Unacceptable | |
|---|---|---|---|---|---|
| Background | Ref | Water content | | Water content | Electrolyte |
| Reference | Abbrev | range | | range (if stated) | components |
| Stevenson, et. al. J. Phys. Chem. | NP1 | | | | Li[PF₆] |
| C 2012, p21208 | | | | | EC:DMC |
| Lucht, et. al. ESSL, 2007, pA115 | NP2 | | | | Li[PF₆] |
| | | | | | EC:DEC:DMC |
| Erfu, et. al. J. Appl. | NP3 | | | | LiOH/NaOH |
| Electrochem. 2010, p197 | | | | | H₂O |
| Dahn, et. al. JES, 2010, pA196 | NP4 | | | | Li[PF₆] |
| | | | | | EC:DMC |
| Yamaki et. al. JAE, 1999, p1191 | NP5 | 0-370 | ppm | | Li[AsF₆] |
| | | | | | 2MeTHF:EC |
| Maier et. al. Adv. Funct. Mater. | NP6 | | | | Li[PF₆] |
| 2011, p1391 | | | | | EC:DMC |
| Xu and Jow (JES, 2002, A586) | NP7 | 0-620 | ppm | | Li[PF₆] or |
| | | | | | Li[BF₄] |
| | | | | | EC:EMC |
| Aurbach, et. al. Electrochimica | NP8 | 20-700 | ppm | | Li[AsF₆] |
| Acta, 1994, p2559 | | | | | EC/DMC |
| U.S. Pat. No. 6,521,375 | PL1 | 10-hundreds of ppm | | | Li[PF₆], |
| | | | | | Li[BF₄], |
| | | | | | Li[MeSO₃] |
| | | | | | EC:DMC |
| US 2011/0250503 | PL2 | 0-50 | ppm | | Aryl |
| | | | | | phosphate, |
| | | | | | Li[PF₆] |
| | | | | | EC:DMC |
| U.S. Pat. No. 6,159,640 | PL3 | 0-10,000 | ppm | | Li salt |
| | | | | | EC:DMC |
| | | | | | R₂NCO₂R′ |
| EP 1,094,537 A2 | PL4 | 0-10,000 | ppm | | Li[PF₆] |
| US 2009/0104520 | PL5 | 0-500 | ppm | >500 ppm | DME, 1,3- |
| | | | | | dioxolane |
| US 2008/0050657 | PL6 | 0-1000 | ppm | | NR₄⁺X⁻ DMC |
| U.S. Pat. No. 6,534,214 | PL7 | 0-1000 | ppm | | PC, DEC, γ- |
| | | | | | BL |
| US 2012/0141886 | PL8 | 200-500 | ppm | | Li salt |
| | | | | | EC:DMC |
| U.S. Pat. No. 4,737,424 | PL9 | 5-400 | ppm | >400 ppm | EC:1,3- |
| | | | | | dioxolane |
| U.S. Pat. No. 6,379,846 | PL10 | 30-800 | ppm | >800 ppm | Li-salt, |
| | | | | | carbonates, |
| | | | | | phosphate |

TABLE 2
Summarizing Battery Water Content Data in Mg-Ion Batteries

| | | Acceptable | Unacceptable | |
|---|---|---|---|---|
| Background | Ref | Water content | Water content | Electrolyte |
| Reference | Abbrev | range | range (if stated) | components |
| U.S. Pat. No. | PL11 | 0-200 ppm | | Mg(ClO₄)₂, |
| 8,211,578 | | | | Li(PF₆) |
| B2 | | | | CH₃CN |
| Novak, et. al. | NP9 | 70-10,000 ppm | | Mg(ClO₄)₂ |
| Electrochimica | | | | THF or |
| Acta, 1999, | | | | CH₃CN |
| p351 | | | | |

There is a need for improved non-aqueous electrolytes for use in secondary batteries.

### SUMMARY OF THE INVENTION

An electrolyte is provided, in which Mg-ions are the charge carriers. In some embodiments, the properties of the electrolyte include high conductivity, total water content of <200 ppm, and an electrochemical window that can exceed 3.0 V vs. Mg/Mg⁺². The use of the electrolyte promotes the deposition and intercalation of Mg without the use of any organometallic species.

An electrolyte for use in electrochemical cells is provided. The properties of the electrolyte include high conductivity, total water content of <200 ppm high Coulombic efficiency, and an electrochemical window that can exceed 3.5 V vs. Mg/Mg²⁺. The use of the electrolyte promotes the electrochemical deposition and dissolution of Mg without the use of any Grignard reagents, organometallic materials, or Lewis acid derived anions including tetrachloroaluminate or tetraphenylborate.

Mg electrolyte solutions containing any amount less than 200 ppm water provide minimal anode polarization and maximum Coulombic efficiency. Addition of water to dry electrolytes results in either increased anode polarization or complete passivation of the Mg anode, resulting in termination of Mg cycling ability. The deleterious reaction of water with the surface of the Mg anode combined with the fact that this phenomenon is not limited to a single electrolyte composition merits the maintenance of all additive free Mg electrolyte solutions at water levels below 200 ppm. This requirement is in contradistinction to Li-ion and other monovalent salt battery electrolytes that are capable of providing optimal cycling performance over a wide range of water content from more than zero to less than several hundred to several thousand ppm of water. It is anticipated that the disparity between water requirements of the Mg vs. Li electrolyte arises from the ability of Mg to simultaneously transfer multiple electrons, which makes it more kinetically capable of water reduction even though Li possesses 0.7 V greater thermodynamic potential to reduce water. Therefore it is expected that other multi-valent battery systems (i.e. Al³⁺, Ca²⁺, etc.) will experience the same problems and should also be included herein.

In some aspects, a non-aqueous electrolyte for use in an electrochemical cell includes (a) at least one organic solvent; and (b) at least one soluble, inorganic Magnesium (Mg) salt complex represented by the formula: MgₐZ_{b}X_{c} wherein a, b, and c are selected to maintain neutral charge of the molecule, and Z and X are selected such that Z and X form a Lewis Acid; and 1≦a≦10, 1≦b≦5, and 2≦c≦30. In some embodiments, Z is selected from a group consisting of aluminum, boron, phosphorus, titanium, iron, and antimony. In certain embodiments, X is selected from the group consisting of I, Br, Cl, F and mixtures thereof.

In another aspect, a non-aqueous electrolyte for use in an electrochemical cell includes (a) at least one organic solvent; (b) at least one soluble, inorganic Magnesium (Mg) salt complex represented by the formula: MgₙZX_{3+(2*n)}, in which Z is selected from a group consisting of aluminum, boron, phosphorus, titanium, iron, and antimony; X is a halogen (I, Br, Cl, F or mixture thereof) and n=1-5.

As described herein, the Magnesium (Mg) salt complex is electrolytically active, i.e., ionically conductive with regards to Mg-ions.

According to further features in preferred embodiments described below, the electrolyte is incorporated into specific Mg-ion electrochemical cells comprised of said electrolyte and an appropriate anode-cathode pair. In one aspect an appropriate anode-cathode pair is a magnesium metal anode and a magnesium insertion-compound cathode. In another aspect an appropriate anode-cathode pair is a magnesium metal anode and a cathode capable of conversion, or displacement reactions. In yet another aspect an appropriate anode-cathode pair is a magnesium metal anode and a catholyte.

The significantly higher Coulombic and energy (voltage) efficiency obtained using electrolytes described herein indicates improved stability for the electrolytic solution allowing substantial increases to the Coulombic efficiency, energy efficiency, cycle life, and the energy density of the battery. Furthermore the present invention enables cheaper, safer, and more chemically stable materials to be utilized for these purposes.

In some specific embodiments described herein solutions formed from combinations of Magnesium Chloride (MgCl₂) and other Magnesium salts in ethereal solvents such as THF and Glyme successfully address the shortcomings of the previously reported Mg electrolytes and provide a basis for the production of a viable, rechargeable magnesium battery with anode polarization between plating and stripping is <500 mV or overall cell wherein the energy efficiency is >65%. In other specific embodiments described herein solutions formed from combinations of MgCl₂ and other salts considered Lewis acidic with respect to MgCl₂ in ethereal solvents such as THF and Glyme successfully address the shortcomings of the previously reported Mg electrolytes and provide a basis for the production of a viable, rechargeable magnesium battery with anode polarization between plating and stripping is <500 mV or overall cell wherein the energy efficiency is >65%.

In some specific embodiments described herein solutions formed of Magnesium salts in non-aqueous solvents such as THF and Glyme successfully address the shortcomings of the previously reported Mg electrolytes and provide a basis for the production of a viable, rechargeable magnesium battery with anode polarization between plating and stripping is <500 mV or overall cell wherein the energy efficiency is >65%. In other specific embodiments described herein solutions formed from combinations of a Magnesium halide and other salts in non-aqueous successfully address the shortcomings of the previously reported Mg electrolytes and provide a basis for the production of a viable, rechargeable magnesium battery with anode polarization between plating and stripping is <500 mV or overall cell wherein the energy efficiency is >65%.

In another embodiment, the Mg molarity is in the range from 0.1 M to 2 M.

In still another embodiment, the solution conductivity is greater than 1 mS/cm at 25 degrees Celsius.

In some specific embodiments described herein, the Magnesium inorganic salt complex includes Magnesium Aluminum Chloride complex (MACC) formed from combinations of MgCl2+AlCl3 in ethereal solvents such as THF and Glyme. In some embodiments, the electrolyte described herein successfully addresses the shortcomings of the presently-known electrolytes and provides the basis for the production of a viable, rechargeable magnesium battery with a voltage exceeding a 2 Volt, or a 3 Volt stability window.

In some specific embodiments described herein solutions formed from combinations of Magnesium Chloride (MgCl₂) and Magnesium bis(trifluoromethylsulfonyl)imide (MgTFSI₂) in ethereal solvents such as THF and Glyme successfully address the shortcomings of the previously reported Mg electrolytes and provide a basis for the production of a viable, rechargeable magnesium battery with a voltage exceeding a 2 Volt stability window.

The significantly wider electrochemical window obtained using electrolytes described herein indicates improved stability for the electrolytic solution and allows the use of more energetic cathode materials, such that both the cycle life and the energy density of the battery are substantially increased. Furthermore the present invention enables cheaper, safer, and more chemically stable materials to be utilized for these purposes.

In one aspect, a non-aqueous electrolyte solution is described, including:

(a) at least one organic solvent; and

(b) at least one electrolytically active, soluble, inorganic Magnesium (Mg) salt complex represented by the formula MgₐZ_{b}X_{c}, and Z and X are selected such that Z and X form a Lewis Acid; and 1≦a≦10, 1≦b≦5, and 2≦c≦30.

In any of the preceding embodiments, a, b, and c are selected to maintain neutral charge of the molecule.

In any of the preceding embodiments, Z is selected from a group consisting of aluminum, boron, phosphorus, titanium, iron, and antimony; and X is selected from the group consisting of I, Br, Cl, F and mixtures thereof.

In any of the preceding embodiments, 1≦a≦10, 1≦b≦2, and 3≦c≦30.

In any of the preceding embodiments, the Magnesium (Mg) salt complex is represented by formula MgₙZX_{3+(2*n)}, and n is from 1 to 5.

In any of the preceding embodiments, the Mg:Z ratio is greater than 1:2.

In another aspect, a non-aqueous Magnesium electrolyte solution is described, including a mixture of Magnesium halide and a compound more Lewis-acidic than the Magnesium halide in at least one organic solvent.

In any of the preceding embodiments, the compound is a Lewis acid.

In any of the preceding embodiments, the molar ratio of Magnesium halide to the compound is greater than 1.

In any of the preceding embodiments, the compound is selected from the group consisting of BI₃, BBr₃, BCl₃, BF₃, AlI₃, AlBr₃, AlCl₃, AlF₃, PI₃, PBr₃, PCl₃, PF₃, BI₃, TiI₄, TiBr₄, TiCl₃, TiCl₄, TiF₃, TiF₄, FeI₂, FeBr₃, FeBr₂, FeCl₃, FeCl₂, FeF₃, FeF₂, SbI₃ SbBr₃, SbCl₃, SbF₃.

In any of the preceding embodiments, the magnesium halide includes magnesium chloride.

In any of the preceding embodiments, the magnesium chloride complex includes a reaction product of MgCl2 and AlCl3.

In any of the preceding embodiments, the Mg:Al ratio is in the range of greater than 0.5.

In any of the preceding embodiments, the Mg molarity in the electrolyte solution is at least 0.1 M.

In any of the preceding embodiments, the organic solvent is one or more solvent selected from the group consisting of ethers, organic carbonates, lactones, ketones, nitriles, ionic liquids, aliphatic and aromatic hydrocarbon solvents and organic nitro solvents.

In any of the preceding embodiments, the organic solvent is one or more solvent selected from the group consisting of THF, 2-methyl THF, dimethoxyethane, diglyme, ethyl diglyme, butyl diglyme, triglyme, tetraglyme, diethoxyethane, diethylether, proglyme, dimethylsulfoxide, dimethylsulfite, sulfolane, acetonitrile, hexane, toluene, nitromethane, 1-3 dioxalane, 1-4 dioxane, trimethyl phosphate, tri-ethyl phosphate, hexa-methyl-phosphoramide (HMPA), N,N-propyl-methyl-pyrrolidinium-bis(trifluoromethylsulfonyl)imide (P13-TFSI), N,N-propyl-methyl-pyrrolidinium-diacetamide (P13-DCA), propyl-methyl-pyrrolidinium-bis(fluorosulfonyl)imide (P13-FSI), ethyl-dimethyl-propyl-ammonium-bis(trifluoromethylsulfonyl)imide (PDEA-TFSI), 1-(methoxyethyl)-1-methylpiperidinium-bis(trifluoromethylsulfonyl)imide (MOEMPP-TFSI), and ionic liquids.

In any of the preceding embodiments, the non-aqueous electrolyte solution is for use in a Magnesium electrochemical cell.

In any of the preceding embodiments, the non-aqueous electrolyte solution is for use in a Magnesium plating bath.

In yet another aspect, a method of preparing a non-aqueous electrolyte solution of any of the preceding embodiments is described, including: combining a source of magnesium, and a source of a metal Z, in an electrolyte solvent.

In yet another aspect, an electrochemical cell is described, including: a non-aqueous electrolyte solution according to one of the preceding embodiments; a magnesium-containing anode and a cathode capable of reversible electrochemical reaction with Magnesium.

In any of the preceding embodiments, the magnesium anode is select from the group consisting of Mg, Mg alloys, electrodeposited Mg, AZ31, AZ61, AZ63, AZ80, AZ81, AZ91, AM50, AM60, Elektron 675, ZK51, ZK60, ZK61, ZC63, M1A, ZC71, Elektron 21, Elektron 675, Elektron, Magnox, or insertion materials such as Anatase TiO2, rutile TiO2, Mo6S8, FeS2, TiS2, MoS2.

In any of the preceding embodiments, the cathode is selected from the group consisting of Chevrel phase Mo₆S₈, MnO₂, CuS, Cu₂S, Ag₂S, CrS₂, VOPO₄, layered structure compounds such as TiS₂, V₂O₅, MgVO₃, MoS₂, MgV₂O₅, MoO₃, Spinel structured compounds such as CuCr₂S₄, MgCr₂S₄, MgMn₂O₄, MgNiMnO₄, Mg₂MnO₄, NASICON structured compounds such as MgFe₂(PO₄)₃ and MgV₂(PO₄)₃, Olivine structured compounds such as MgMnSiO₄ and MgFe₂(PO₄)₂, Tavorite structured compounds such as Mg_{0.5}VPO₄F, pyrophosphates such as TiP₂O₇ and VP₂O₇, and fluorides such as MgMnF₄ and FeF₃.

According to one aspect, the invention features a rechargeable magnesium battery having a non-aqueous electrolyte solution. The rechargeable magnesium battery comprises an anode electrode, a cathode electrode and the non-aqueous electrolyte solution in contact with the anode electrode and the cathode electrode. The non-aqueous electrolyte solution comprises at least one organic solvent; and at least one electrolytically active, soluble, inorganic Magnesium (Mg) salt complex represented by the formula Mgₙ₊₁X_{(2*n)}Z₂ in which n is in the range from one-quarter to four, X is a halide, and Z is an inorganic polyatomic monovalent anion.

In one embodiment, the Z is a polyatomic monovalent anion selected from the group of polyatomic monovalent anions described in Table I, and mixtures thereof.

In one another embodiment, n is 3, the halide is chlorine, and Z is the univalent negative ion N(CF₃SO₂)₂⁻¹ to form a solution of 2Mg₂Cl₃⁺2[N(CF₃SO₂)₂⁻¹].

In another embodiment, the Mg molarity is in the range from 0.1 M to 1 M.

In a further embodiment, the Mg molarity is in the range from 0.25 M to 0.5 M.

In another embodiment, the n is in the range from 0.25 to 4, the halide is chlorine.

In yet another embodiment, the n is in the range from 0.25 to 4, the halide is chlorine, and Z is N(CF₃SO₂)₂⁻¹.

In still another embodiment, a Mg molarity is in the range from 0.1 M to 2 M.

In a further embodiment, a solution conductivity is greater than 1 mS/cm at 25 degrees Celsius.

In yet a further embodiment, a solution Coulombic efficiency is greater than 98% at 25 degrees Celsius.

In an additional embodiment, the at least one organic solvent is a solvent selected from the group consisting of an ether, an organic carbonate, a lactone, a ketone, a glyme, a nitrile, an ionic liquid, an aliphatic hydrocarbon solvent, an aromatic hydrocarbon solvent and an organic nitro solvent, and mixtures thereof.

In one more embodiment, the at least one organic solvent is a solvent selected from the group consisting of THF, 2-methyl THF, dimethoxyethane, diglyme, triglyme, tetraglyme, diethoxyethane, diethylether, proglyme, ethyl diglyme, butyl diglyme, dimethylsulfoxide, dimethylsulfite, sulfolane, ethyl methyl sulfone, acetonitrile, hexane, toluene, nitromethane, 1-3 dioxalane, 1-4 dioxane, trimethyl phosphate, tri-ethyl phosphate, hexa-methyl-phosphoramide (HMPA), N,N-propyl-methyl-pyrrolidinium-bis(trifluoromethylsulfonyl)imide (P13-TFSI), N,N-propyl-methyl-pyrrolidinium-diacetamide (P13-DCA), propyl-methyl-pyrrolidinium-bis(fluorosulfonyl)imide (P13-FSI), ethyl-dimethyl-propyl-ammonium-bis(trifluoromethylsulfonyl)imide (PDEA-TFSI), 1-(methoxyethyl)-1-methylpiperidinium-bis(trifluoromethylsulfonyl)imide (MOEMPP-TFSI), and mixtures thereof.

In one more embodiment, at least one organic solvent comprises at least one of THF and dimethoxyethane.

In still a further embodiment, the at least one organic solvent comprises at least one of THF, dimethoxyethane, ethyl diglyme, and butyl diglyme.

According to another aspect, the invention relates to a non-aqueous electrolyte solution for use in an electrochemical cell with a total water content of <200 ppm. The non-aqueous electrolyte solution comprises at least one organic solvent; and a magnesium halide complex that is a reaction product of magnesium halide and a magnesium salt containing a polyatomic univalent anion of anodic stability limit greater than 3 V vs. Mg/Mg²⁺.

In one embodiment, the magnesium salt containing a polyatomic univalent anion of anodic stability limit greater than 3 V vs. Mg/Mg²⁺. is selected from the group of polyatomic univalent anions described in Table I and mixtures thereof.

In another embodiment, the magnesium halide to magnesium salt ratio is in the range of 4:1, 3:1, 2:1 or 1:1.

In yet another embodiment, the magnesium halide to magnesium salt ratio is in any proportion between 4:1 and 1:1.

In still another embodiment, the Mg molarity is in the range of 0.1 M to 1 M.

In a further embodiment, the Mg molarity is in the range of 0.25 M to 0.5 M.

According to another aspect, the invention relates to a rechargeable magnesium battery having a non-aqueous electrolyte with a total water content of <200 ppm. The non-aqueous electrolyte solution comprises at least one organic solvent; and a magnesium halide complex that is a reaction product of magnesium halide and another inorganic salt containing a polyatomic monovalent anion of anodic stability limit greater than 2.5 V vs. Mg/Mg²⁺.

In one embodiment, the magnesium salt containing a polyatomic monovalent anion of anodic stability limit greater than 2.5 V vs. Mg/Mg²⁺ is selected from the group of polyatomic monovalent anions described in Table I, and mixtures thereof.

In another embodiment, the magnesium halide is a magnesium chloride.

In yet another embodiment, the magnesium halide to magnesium salt ratio is in the range from 4:1 and 1:4.

In still another embodiment, a Mg molarity is in the range from 0.1 M to 2 M.

In a further embodiment, a solution conductivity is greater than 1 mS/cm at 25 degrees Celsius.

In yet a further embodiment, a solution Coulombic efficiency is greater than 98% at 25 degrees Celsius.

In an additional embodiment, the at least one organic solvent is a solvent selected from the group consisting of an ether, an organic carbonate, a lactone, a ketone, a glyme, a nitrile, an ionic liquid, an aliphatic hydrocarbon solvent, an aromatic hydrocarbon solvent and an organic nitro solvent, and mixtures thereof.

In one more embodiment, the at least one organic solvent is a solvent selected from the group consisting of THF, 2-methyl THF, dimethoxyethane, diglyme, triglyme, tetraglyme, diethoxyethane, diethylether, proglyme, ethyl diglyme, butyl diglyme, dimethylsulfoxide, dimethylsulfite, sulfolane, ethyl methyl sulfone, acetonitrile, hexane, toluene, nitromethane, 1-3 dioxalane, 1-4 dioxane, trimethyl phosphate, tri-ethyl phosphate, hexa-methyl-phosphoramide (HMPA), N,N-propyl-methyl-pyrrolidinium-bis(trifluoromethylsulfonyl)imide (P13-TFSI), N,N-propyl-methyl-pyrrolidinium-diacetamide (P13-DCA), propyl-methyl-pyrrolidinium-bis(fluorosulfonyl)imide (P13-FSI), ethyl-dimethyl-propyl-ammonium-bis(trifluoromethylsulfonyl)imide (PDEA-TFSI), 1-(methoxyethyl)-1-methylpiperidinium-bis(trifluoromethylsulfonyl)imide (MOEMPP-TFSI), and mixtures thereof.

In still a further embodiment, the at least one organic solvent comprises at least one of THF and dimethoxyethane.

In still a further embodiment, the at least one organic solvent comprises at least one of THF, dimethoxyethane, ethyl diglyme, and butyl diglyme.

According to another aspect, the invention relates to a method of preparing a non-aqueous electrolyte solution with a total water content of <200 ppm. The method comprises the step of reacting a magnesium halide and a magnesium salt of formula MgZ₂, where Z is a polyatomic monovalent anion. In one embodiment, Z is a polyatomic monovalent anion selected from the polyatomic monovalent anions described in Table I, and mixtures thereof.

In one embodiment, the magnesium halide is magnesium chloride, the magnesium salt is Mg[N(CF₃SO₂)₂]₂, and the solvent is a mixture of THF and DME.

In one embodiment, the magnesium halide is magnesium chloride, the magnesium salt is Mg[N(CF₃SO₂)₂]₂, and the solvent is THF, DME, ethyl diglyme, butyl diglyme, or a mixture thereof.

In another embodiment, the magnesium halide:MgZ₂ mole ratio is in the range from 4:1 to 1:4.

In another embodiment, the magnesium halide:MgZ₂ ratio is in the range of 4:1, 3:1, 2:1, or 1:1.

In yet another embodiment, the magnesium halide:MgZ₂ mole ratio is in any proportion between 4:1 and 1:1.

In still another embodiment, the method further comprises stirring the solvent and heating the solvent during the reaction.

In a further embodiment, the solvent is heated to a temperature between 20° C. and 50° C. during the reaction.

In yet a further embodiment, the reaction is carried out for a duration in the range of 1 to 72 hours.

In an additional embodiment, the method further comprises the step of conditioning the non-aqueous electrolyte solution by electrochemical polarization.

In one more embodiment, the conditioning step comprises exposing the non-aqueous electrolyte solution to a substance selected from the group of substances consisting of Mg metal, Al metal, Ca metal, Li metal, Na metal, K metal, an insoluble acid, an insoluble base, and an adsorbing agent.

In still a further embodiment, the adsorbing agent is selected from the group consisting of a molecular sieve, CaH₂, alumina, silica, and MgCO₃.

In still another embodiment, the conditioning step comprises exposing the non-aqueous electrolyte solution to a substance that scavenges a contaminant, the contaminant selected from the group of substances consisting of an organo-Mg compound, an organo-Al compound, an organo-B compound, AlCl₃, an organometallic compound, a trace amount of water, a trace amount of oxygen and a trace amount of CO₂, and a proton donor (or a protic contaminant such as an acid).

According to another aspect, the invention relates to an electrochemical cell. The electrochemical cell comprises a non-aqueous electrolyte solution according to claim 1 with a total water content of <200 ppm; a magnesium anode and a magnesium intercalation cathode.

According to another aspect, the invention features an electrochemical cell. The electrochemical cell comprises a non-aqueous electrolyte solution with a total water content of <200 ppm comprising at least one organic solvent; and at least one electrolytically active, soluble, inorganic Magnesium (Mg) salt complex represented by the formula Mgₙ₊₁X_{(2*n)}Z₂ in which n is in the range from one-quarter to four, X is a halide, and Z is an inorganic polyatomic monovalent anion; a magnesium anode and a cathode capable of magnesium intercalation, conversion, or displacement reaction.

In one embodiment, the magnesium anode is selected from the group consisting of Mg metal, Anatase TiO₂, rutile TiO₂, Mo₆S₈, FeS₂, TiS₂, and MoS₂.

In another embodiment, the Mg alloy is selected from the group of Mg alloys consisting of AZ31, AZ61, AZ63, AZ80, AZ81, AZ91, AM50, AM60, Elektron 675, ZK51, ZK60, ZK61, ZC63, MIA, ZC71, Elektron 21, Elektron 675, Elektron, and Magnox.

In yet another embodiment, the magnesium intercalation cathode is selected from the group consisting of Chevrel phase Mo₆S₈, MnO₂, CuS, Cu₂S, Ag₂S, CrS₂, VOPO₄, a layered structure compound, a spinel structured compound, a zinc blende structure, a rock salt structured compound, a NASICON structured compound, a Cadmium iodide structured compound, an Olivine structured compound, a Tavorite structured compound, a pyrophosphate, a monoclinic structured compound, and a fluoride.

In still another embodiment, the layered structure compound is selected from the group consisting of TiS₂, V₂O₅, MgVO₃, MoS₂, MgV₂O₅, and MoO₃.

In a further embodiment, the spinel structured compound is selected from the group consisting of CuCr₂S₄, MgCr₂S₄, MgMn₂O₄, MgNiMnO₄, and Mg₂MnO₄.

In yet a further embodiment, the NASICON structured compound is selected from the group consisting of MgFe₂(PO₄)₃ and MgV₂(PO₄)₃.

In an additional embodiment, the Olivine structured compound is selected from the group consisting of MgMnSiO₄ and MgFe₂(PO₄)₂.

In one more embodiment, the Tavorite structured compound is Mg_{0.5}VPO₄F. In still a further embodiment, the pyrophosphate is selected from the group consisting of TiP₂O₇ and VP₂O₇.

In one embodiment, the fluoride is selected from the group consisting of MgMnF₄ and FeF₃.

According to one aspect, the invention features a non-aqueous electrolyte solution for use in an electrochemical cell. The non-aqueous electrolyte solution comprises at least one organic solvent; and at least one electrolytically active, soluble, inorganic Magnesium (Mg) salt complex represented by the formula Mgₙ₊₁X_{(2*n)}Z₂ in which n is in the range from one-quarter to four, X is a halide, and Z is an inorganic polyatomic monovalent anion.

In one embodiment, the Z is a polyatomic monovalent anion selected from the group of polyatomic monovalent anions described in Table I, and mixtures thereof.

In another embodiment, the n is in the range from 0.25 to 4, the halide is chlorine.

In yet another embodiment, the n is in the range from 0.25 to 4, the halide is chlorine, and Z is N(CF₃SO₂)₂⁻¹.

In still another embodiment, a Mg molarity is in the range from 0.1 M to 2 M.

In a further embodiment, a solution conductivity is greater than 1 mS/cm at 25 degrees Celsius.

In yet a further embodiment, a solution Coulombic efficiency is greater than 98% at 25 degrees Celsius.

In an additional embodiment, the at least one organic solvent is a solvent selected from the group consisting of an ether, an organic carbonate, a lactone, a ketone, a glyme, a nitrile, an ionic liquid, an aliphatic hydrocarbon solvent, an aromatic hydrocarbon solvent and an organic nitro solvent, and mixtures thereof.

In one more embodiment, the at least one organic solvent is a solvent selected from the group consisting of THF, 2-methyl THF, dimethoxyethane, diglyme, triglyme, tetraglyme, diethoxyethane, diethylether, proglyme, ethyl diglyme, butyl diglyme, dimethylsulfoxide, dimethylsulfite, sulfolane, ethyl methyl sulfone, acetonitrile, hexane, toluene, nitromethane, 1-3 dioxalane, 1-4 dioxane, trimethyl phosphate, tri-ethyl phosphate, hexa-methyl-phosphoramide (HMPA), N,N-propyl-methyl-pyrrolidinium-bis(trifluoromethylsulfonyl)imide (P13-TFSI), N,N-propyl-methyl-pyrrolidinium-diacetamide (P13-DCA), propyl-methyl-pyrrolidinium-bis(fluorosulfonyl)imide (P13-FSI), ethyl-dimethyl-propyl-ammonium-bis(trifluoromethylsulfonyl)imide (PDEA-TFSI), 1-(methoxyethyl)-1-methylpiperidinium-bis(trifluoromethylsulfonyl)imide (MOEMPP-TFSI), and mixtures thereof.

In still a further embodiment, the at least one organic solvent comprises at least one of THF, dimethoxyethane, ethyl diglyme, and butyl diglyme.

According to another aspect, the invention relates to a non-aqueous electrolyte solution with a total water content of <200 ppm for use in an electrochemical cell. The non-aqueous electrolyte solution comprises at least one organic solvent; and a magnesium halide complex that is a reaction product of magnesium halide and another inorganic salt containing a polyatomic monovalent anion of anodic stability limit greater than 2.5 V vs. Mg/Mg²⁺.

In one embodiment, the magnesium salt containing a polyatomic monovalent anion of anodic stability limit greater than 2.5 V vs. Mg/Mg²⁺ is selected from the group of polyatomic monovalent anions described in Table I, and mixtures thereof.

In another embodiment, the magnesium halide is a magnesium chloride. In yet another embodiment, the magnesium halide to magnesium salt ratio is in the range from 4:1 and 1:4.

In still another embodiment, a Mg molarity is in the range from 0.1 M to 2 M. In a further embodiment, a solution conductivity is greater than 1 mS/cm at 25 degrees Celsius.

In yet a further embodiment, a solution Coulombic efficiency is greater than 98% at 25 degrees Celsius.

In an additional embodiment, the at least one organic solvent is a solvent selected from the group consisting of an ether, an organic carbonate, a lactone, a ketone, a glyme, a nitrile, an ionic liquid, an aliphatic hydrocarbon solvent, an aromatic hydrocarbon solvent and an organic nitro solvent, and mixtures thereof.

In one more embodiment, the at least one organic solvent is a solvent selected from the group consisting of THF, 2-methyl THF, dimethoxyethane, diglyme, triglyme, tetraglyme, diethoxyethane, diethylether, proglyme, ethyl diglyme, butyl diglyme, dimethylsulfoxide, dimethylsulfite, sulfolane, ethyl methyl sulfone, acetonitrile, hexane, toluene, nitromethane, 1-3 dioxalane, 1-4 dioxane, trimethyl phosphate, tri-ethyl phosphate, hexa-methyl-phosphoramide (HMPA), N,N-propyl-methyl-pyrrolidinium-bis(trifluoromethylsulfonyl)imide (P13-TFSI), N,N-propyl-methyl-pyrrolidinium-diacetamide (P13-DCA), propyl-methyl-pyrrolidinium-bis(fluorosulfonyl)imide (P13-FSI), ethyl-dimethyl-propyl-ammonium-bis(trifluoromethylsulfonyl)imide (PDEA-TFSI), 1-(methoxyethyl)-1-methylpiperidinium-bis(trifluoromethylsulfonyl)imide (MOEMPP-TFSI), and mixtures thereof.

In still a further embodiment, the at least one organic solvent comprises at least one of THF, dimethoxyethane, ethyl diglyme, and butyl diglyme.

According to another aspect, the invention relates to a rechargeable magnesium battery having a non-aqueous Mg electrolyte solution with a total water content of <200 ppm. The rechargeable magnesium battery having a non-aqueous electrolyte solution comprises at least one organic solvent, and a magnesium salt. As used herein, the terms battery, cell, and electrochemical cell are used interchangeably to describe the combination of a positive electrode, a negative electrode, and a non-aqueous Mg electrolyte. The non-aqueous Mg electrolyte can comprise one or more Mg salts in one or more non-aqueous solvents and a total water content of <200 ppm that allows for highly reversible electrodeposition and stripping of Mg from the negative electrode.

In another aspect, the invention relates to a rechargeable magnesium battery having a non-aqueous Mg electrolyte solution. The non-aqueous Mg electrolyte solution can comprise at least one organic solvent, at least one magnesium salt, and a total water content of <200 ppm. The rechargeable magnesium battery can display high Coulombic efficiency and energy efficiency.

In yet another aspect, the invention relates to a rechargeable magnesium battery having a non-aqueous Mg electrolyte solution. The non-aqueous Mg electrolyte solution can comprise at least one organic solvent, at least one magnesium salt, and a total water content of <200 ppm. The rechargeable magnesium battery can display Coulombic efficiency >98%, and energy efficiency >65%.

In another aspect, the invention relates to a cell containing a Mg metal, or alloy, electrode in contact with a non-aqueous Mg electrolyte solution. The non-aqueous Mg electrolyte solution can comprise at least one organic solvent, at least one magnesium salt, and a total water content of <200 ppm. The rechargeable magnesium battery can display high Coulombic efficiency and low anode polarization measured between the electrodeposition and stripping of the Mg metal, or alloy, electrode and said electrolyte.

In yet another aspect, the invention relates to a cell containing a Mg metal, or alloy, electrode in contact with a non-aqueous Mg electrolyte solution. The non-aqueous Mg electrolyte solution can comprise at least one organic solvent, at least one magnesium salt, and a total water content of <200 ppm. The rechargeable magnesium battery can display Coulombic efficiency >98%, and <500 mV anode polarization measured between the electrodeposition and stripping of the Mg metal, or alloy, electrode and said electrolyte.

In one embodiment, the magnesium anode is selected from the group consisting of Mg metal and an alloy containing Mg.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a graph displaying a typical cyclic voltammogram of the all-inorganic Magnesium Aluminum Chloride complex dissolved in tetrahydrofuran (THF). The experiment utilized 25 mV/s scan rate and a platinum working electrode, and Mg for the counter and reference electrodes.

FIG. 2 depicts the Mg—Al—Cl ternary phase diagram derived from the ab initio calculated energies of compounds within that system. Each point represents a thermodynamically stable compound and the space within each triangular plane represents compositional space wherein a mixture of the 3 vertex compounds is thermodynamically stable to the voltage vs. Mg/Mg²⁺ indicated within that triangle.

FIG. 3 shows representative cyclic voltammogram of the all-inorganic Magnesium Aluminum Chloride complex dissolved in tetrahydrofuran (THF) using a platinum working electrode, and Mg for the counter and reference electrodes. The voltammogram depicted in black illustrates the significant hysteresis between Mg plating and stripping while the voltammogram depicted in grey depicts the same solution with significantly improved plating ability due to electrochemical conditioning. The experiment utilized 25 mV/s scan rate and a platinum working electrode, and Mg for the counter and reference electrodes.

FIG. 4 displays chronopotentiometry of a symmetric cell wherein all electrodes are Mg metal. The data was taken for 100 hours at an applied current of ˜0.1 mA/cm².

FIG. 5 is a graph of cyclic voltammetry for Mo₆S₈ cathode in Magnesium-Aluminum-Chloride Complex solution. This experiment utilizes Mg counter and reference electrode. The current response obtained corresponds to about 80 mAh/g over multiple charge/discharge cycles.

FIG. 6 is a graph displaying a typical cyclic voltammogram of the all-inorganic Mg₂Cl₃-TFSI complex resulting from reaction of MgCl₂ and Mg(TFSI)₂ dissolved in a mixture of 1,2-dimethoxymethane (DME) and tetrahydrofuran (THF).

FIG. 7 is a graph displaying comparison of typical cyclic voltammograms of the inorganic magnesium salt complex resulting from reaction of MgCl₂ and Mg(TFSI)₂ when the mole ratio is varied between the two reactants.

FIG. 8 is a graph displaying a typical macrocoulometry cycling data for the inorganic magnesium salt complex Mg₃Cl₄(TFSI) resulting from reaction of 2MgCl₂ and 1Mg(TFSI)₂ in a mixed solution of 1,2-dimethoxymethane (DME) and N,N-propyl-methyl-pyrrolidinium-bis(trifluoromethylsulfonyl)imide (P13-TFSI) ionic liquid.

FIG. 9 is a graph displaying a typical cyclic voltammograms of the inorganic magnesium salt complex resulting from reaction of MgCl₂ and Mg(TFSI)₂ when the solvent utilized is a combination of butyl diglyme and the ionic liquid N,N-propyl-methyl-pyrrolidinium-bis(trifluoromethylsulfonyl)imide.

FIG. 10 is a graph displaying three cycles of a typical cyclic voltammogram demonstrating the high degree of Coulombic efficiency obtained with an all-inorganic magnesium aluminum chloride complex salt dissolved in a tetrahydrofuran (THF) and containing less than about 110 ppm of water.

FIG. 11 depicts three cycles of a typical cyclic voltammogram demonstrating the low degree of Coulombic efficiency obtained with an all-inorganic magnesium aluminum chloride complex salt dissolved in a tetrahydrofuran (THF) when the total water content is increased to about 230 ppm of water.

FIG. 12 shows the comparison of typical cyclic voltammograms (5th cycle shown for clarity) of an electrolyte with total water content less than about 50 ppm (“Dry”, solid line) as compared to an Mg electrolyte solution with content of greater than about 150 ppm H2O (“Wet”, dotted line). The latter shows somewhat increased voltage hysteresis and decreased current response as compared to the <50 ppm sample. The non-aqueous Magnesium electrolyte solution contains 0.25 M MgCl₂ and 0.125 M Magnesium bis(trifluoromethylsulfonyl)imide in 1,2-dimethoxyethane.

FIG. 13 shows the significant increase in polarization, or voltage hysteresis, of an Mg metal anode during galvanostatic cycling due to the addition of water. The Mg anode polarization increases two to three times that of a dry Mg electrolyte cell when the total water content of the electrolyte increases above the threshold limit of 200 ppm.

### DETAILED DESCRIPTION

As used herein, the terms “dry Mg electrolyte,” “non-aqueous Magnesium electrolyte,” and “non-aqueous Mg electrolyte” are defined as an electrolyte comprising Mg ions that contains less than 200 ppm of total water content. Total water content can include water contained in starting materials as received from a vendor, water contained in starting materials as treated prior to inclusion in the electrolyte, and water that may be deliberately added as part of the process of preparing the electrolyte. As used herein, the term “catholyte” is defined as a positive electrode active material when it is dissolved in the electrolyte solution. As used herein, the term “multi-valent battery” is defined as a battery wherein an ion being transferred between electrodes is either not monovalent, or provides a specific capacity equivalent to greater than one electron per ion transferred between negative and positive electrodes during discharge. Non-limiting examples of multi-valent battery ions include charged species of Mg, Ca, Al, Zn, and Y. As used herein, the term “additive” is defined as lithium hexafluorophosphate (LiPF₆) between 0.5 and 4 percent by weight of an electrolyte.

An electrolyte is described herein for transferring Mg-ions between electrodes. The properties of the electrolyte include high conductivity and an electrochemical window that can exceed 3.0 V vs. Mg/Mg2+. The use of an inorganic salt complex in an electrolyte promotes the substantially-reversible deposition of magnesium metal on the anode current collector and the reversible intercalation of magnesium in the cathode material.

An electrolyte is described for use in electrochemical cells that transfer Mg-ions between electrodes. The properties of the electrolyte include high conductivity, and total water content <200 ppm to promote high energy efficiency and high Coulombic efficiency, and an electrochemical window that can exceed 3.5 V vs. Mg/Mg²⁺. The use of an inorganic salt complex in an electrolyte promotes the substantially reversible deposition of magnesium metal on the anode current collector and the reversible intercalation of magnesium in the cathode material. It is expected that the systems, materials, and methods described will provide an improved non-aqueous electrolyte that allows the production of a practical, rechargeable magnesium battery which is expected to be safer and cleaner, and more durable, efficient and economical than heretofore known.

Furthermore the abundance of Mg metal and readily available compounds containing Mg is expected to offer significant cost reduction relative to Li-ion batteries. Magnesium also offers superior safety and waste disposal characteristics.

Consequently a great deal of collective effort has been put towards understanding how the amount of water effects performance in a Li-ion cell and what are the tolerable limits while the comparatively nascent field of Mg-ion batteries not yet ascertained this understanding to the same degree.

In some embodiments, the electrolyte is for use in electrochemical cells, e.g., a magnesium electrochemical cell. In other embodiments, the electrolyte can be used in Magnesium plating baths, where electrochemical deposits of high purity Mg, or Mg-containing materials are prepared upon electronically conductive substrates. In such systems the electrolyte enables transfer of Mg ions from an Mg source being oxidized, e.g., low purity Magnesium electrode, to a cathode wherein the Mg ions are reduced onto an electronically conducting substrate, so as to create an Mg containing surface layer, which may be further processed.

In one aspect, a non-aqueous Magnesium electrolyte solution is described, including a mixture of Magnesium halide and a Lewis Acid in at least one organic solvent. The molar ratio of Magnesium halide to Lewis Acid can be 1, greater than 1, or less than 1. In some embodiments, the molar ratio of Magnesium halide to Lewis Acid is greater than 1, and the mixture is referred to as a “basic” mixture. In other embodiments, the molar ratio of Magnesium halide to Lewis Acid is less than 1, and the mixture is referred to as an “acidic” mixture.

We now provide example electrolytes that are expected to be suitable for Mg-based secondary battery systems. In particular, materials contemplated for use in the electrolytes of the invention can be described by the general formula Mg₂X₃Z, where X is a monovalent negative ion such as a halide (e.g., F⁻¹, Cl⁻¹, Br⁻¹, I⁻¹), and Z is a polyatomic monovalent negative ion. Examples of polyatomic monovalent anions that are believed to be useful in practicing the invention include, but are not limited to, those described in Table 3, and mixtures thereof.

In some embodiments, the non-aqueous electrolyte solution contains the active cation for the electrochemical cell, e.g., magnesium ion. The non-aqueous electrolyte solution can include a magnesium inorganic salt complex, which may be a reaction product of magnesium halide and a compound more Lewis acidic than the magnesium halide. In some embodiments, the compound is a Lewis acid. The non-aqueous electrolyte solution can include a mixture of a magnesium halide and a Lewis acid. The mixture can be a magnesium halide-Lewis acid complex, so as to form an Mg-halide species, which may can a monovalent charge in solution, or involve multiple Mg and halide species.

The term “Lewis Acid,” is well-known in the art and may include any compound generally considered as a Lewis acid or a compound which is more Lewis-acidic than the magnesium halide. In certain embodiments, MgCl₂, can be used as Lewis acid due to its stronger Lewis-acidity in comparison with certain magnesium halides.

TABLE 3

| Chemical name | Acronym | Formula |
|---|---|---|
| bis(perfluoroalkylsulfonyl)imides | | N((CxF₂ₓ₊₁)ₓSO₂)₂⁻¹ |
| bis(fluorosulfonyl)imide | FSI | N(SO₂F)⁻¹ |
| | (x = 0) | |
| bis(trifluoromethanesulfonyl)imide | TFSI | N(CF₃SO₂)⁻¹ |
| | (x = 1) | |
| bis(perfluoroethylsulfonyl)imide | BETI | N(C₂F₅SO₂)₂⁻¹ |
| | (x = 2) | |
| Dicyanamide | DCA | N(CN)₂⁻¹ |
| Tricyanomethide | TCM | C(CN)⁻¹ |
| tetracyanoborate | TCB | B(CN)⁻¹ |
| 2,2,2,-trifluoro-N- | | N(CF₃SO₂) (CF₃CO)⁻¹ |
| (trifluoromethylsulfonyl)acetamide | | |
| tetrafluoroborate | | BF₄⁻¹ |
| hexafluorophosphate | | PF₆⁻¹ |
| triflate | | CF₃SO⁻¹ |
| bis(oxalate)borate | BOB | B(C₂O₄)₂⁻¹ |
| perchlorate | | ClO₄⁻¹ |
| hexafluoroarsenate | | AsF₆⁻¹ |
| Hexafluoroantimonate | | SbF₆⁻¹ |
| Perfluorobutylsulfonate | | (C₄F₉SO₃)⁻¹ |
| Tris(trifluoromethanesulfo- | | C(CF₃SO₂)⁻¹ |
| nyl)methide | | |
| trifluoroacetate | | CF₃CO⁻¹ |
| heptafluorobutanoate | | C₃F₇CO₂⁻¹ |
| thiocyanate | | SCN⁻¹ |
| triflinate | | CF₃SO⁻¹ |

In one aspect, a non-aqueous electrolyte for use in an electrochemical cell includes (a) at least one organic solvent; and (b) at least one electrolytically active, soluble, inorganic Magnesium (Mg) salt complex represented by the formula: MgₐZ_{b}X_{c} wherein a, b, and c are selected to maintain neutral charge of the molecule, and Z and X are selected such that Z and X form a Lewis Acid; and 1≦a≦10, 1≦b≦5, and 2≦c≦30. In some embodiments, Z is selected from a group consisting of aluminum, boron, phosphorus, titanium, iron, and antimony. In certain embodiments, X is selected from the group consisting of I, Br, Cl, F and mixtures thereof.

In certain embodiments, a can be in the range of: 1≦a≦10, 1≦a≦5, 1≦a≦4, 1≦a≦3, 1≦a≦2, 1≦a≦1.5, 2≦a≦10, 2≦a≦5, 2≦a≦4, 2≦a≦3, 2≦a≦2.5, 3≦a≦10, 3≦a≦5, 4≦a≦10, 4≦a≦5, or 4.5≦a≦5. In certain embodiments, b can be in the range of: 1≦b≦5, 1≦b≦4, 1≦b≦3, 1≦b≦2, 1≦b≦1.5, 2≦b≦5, 2≦b≦4, 2≦b≦3, 2≦b≦2.5, 3≦b≦5, 4≦b≦5, or 4.5≦b≦5. In certain embodiments, c can be in the range of: 2≦c≦30, 3≦c≦30, 4≦c≦30, 5≦c≦30, 10≦c≦30, 15≦c≦30, 20≦c≦30, 25≦c≦30, 2≦c≦25, 3≦c≦25, 4≦c≦25, 5≦c≦25, 10≦c≦25, 15≦c≦25, 20≦c≦25, 2≦c≦20, 3≦c≦20, 4≦c≦20, 5≦c≦20, 10≦c≦20, 15≦c≦20, 2≦c≦15, 3≦c≦15, 4≦c≦15, 5≦c≦15, 10≦c≦15, 2≦c≦10, 3≦c≦10, 4≦c≦10, 5≦c≦10, 2≦c≦5, 3≦c≦5, or 4≦c≦5. In these embodiments, any range of a can be used in combination with any range of b and any range of c in the Mg salt complex described herein. Likewise, any range of b can be used in combination with any range of a and any range of c in the Mg salt complex described herein. Furthermore, any range of c can be used in combination with any range of a and any range of b in the Mg salt complex described herein.

In certain embodiments, the Mg salt complex is represented by formula MgₐZ_{b}X_{c} wherein 1≦a≦10, 1≦b≦2, and 3≦c≦30.

In another aspect, a non-aqueous electrolyte for use in an electrochemical cell includes (a) at least one organic solvent; and (b) at least one electrolytically active, soluble, inorganic Magnesium (Mg) salt complex represented by the formula: MgₙZX_{3+(2*n)}, in which Z is selected from a group consisting of aluminum, boron, phosphorus, titanium, iron, and antimony; X is a halogen (I, Br, Cl, F or mixture thereof) and n=1-5. The ratio of Mg to Z can vary from 1:2 to 5:1. In certain embodiments, the ratio of Mg to Z is 5:1, 4:1, 3:1, 2:1, 1:1, or 1:2; however, any non-whole number ratio may also be used. In certain embodiments, the ratio of Mg to Z is from 1:2 to 4:1, from 1:2 to 3:1, from 1:2 to 2:1, from 1:2 to 1:1, from 1:1 to 5:1, from 1:1 to 4:1, from 1:1 to 3:1, from 1:1 to 2:1, from 1:1 to 1.5, from 2:1 to 5:1, from 2:1 to 4:1, from 2:1 to 3:1, from 3:1 to 5:1, from 3:1 to 4:1, or from 4:1 to 5:1.

The electrolyte salt complex can be used at any concentration. In certain embodiments, the Mg concentration in molarity ranges up to 1M or 2 M. In one or more embodiments, the electrolyte salt complex has a Mg concentration in molarity of about 0.25 to about 0.5 M. In one or more embodiments, the electrolyte salt complex has a Mg concentration in molarity of at least about 0.1, 0.25, 0.5, 1.0, 1.5, or 2 M.

In some embodiments, n is greater than 0. In some embodiments, n is greater than 0.5. In some embodiments, n is 0.5, 0.6, 0.8, 1, 1.5, 2, 2.5, 3, 3.5, 4, 4.5, 5, 5.5, or 6.

In one aspect, a non-aqueous electrolyte for use in an electrochemical cell includes (a) at least one organic solvent; (b) at least one electrolytically active, soluble, inorganic Magnesium (Mg) salt complex represented by the formula: MgₙZX_{3+(2*n)}, in which Z is selected from a group consisting of aluminum, boron, phosphorus, titanium, iron, and antimony; X is a halogen (I, Br, Cl, F or mixture thereof) and n=1-5. The ratio of Mg to Z can vary from 1:1 to 5:1. In certain embodiments, the ratio of Mg to Z is 4:1, 3:1 or 2:1; however, any non-whole number ratio may also be used. The electrolyte salt complex can be used at any concentration; however, in certain embodiments, the Mg molarity, e.g., concentration, ranges up to 1 M. In one or more embodiments, the electrolyte salt complex had a Mg concentration of about 0.25 to about 0.5 M.

Previously, the only electrolyte solutions proven to reversibly electrodeposit Mg metal at or near room temperature required a Grignard reagent, or another organometallic reagent with metal-organic bonds. However, the organometallic compounds, and complexes thereof, do not provide operating stability at voltages greater than 2 V. It has been surprisingly discovered that the non-aqueous electrolyte as disclosed herein provides operating stability at voltages greater than 2 V. According to one or more embodiments, the non-aqueous electrolyte as disclosed herein is capable of higher voltage stability while maintaining the ability to electrochemically deposit and strip Mg-ions in facile, reversible manner with low overpotential.

While not being bound by any particular mode of operation, it is hypothesized that the capability for reversible Mg deposition is accomplished via the formation of Magnesium halide salt cations, e.g., MgCl⁺ and/or Mg₂Cl₃⁺ species in solution. It is suggested that these species undergo two-electron reduction of Mg²⁺ to Mg⁰ while avoiding reduction of the anion by reactions similar to the following:

2MgCl⁺+2e⁻→MgCl₂+Mg⁰.

Cationic species using other halides, such as MgF⁺ and/or Mg₂F₃⁺ species may also be suitable for reversible Mg deposition.

A suitable anion is used to maintain charge balance, enable complex formation, solubility in organic solvents, and ionic dissociation. In one preferred embodiment, this is demonstrated by a strong Lewis Acid such as AlCl₃ reacting with Lewis Basic MgCl₂, which drives the following example reaction:

2MgCl₂+AlCl₃→Mg₂Cl₃⁺+AlCl₄⁻

The product can be described as Mg₂AlCl₇ salt or more generally as a Magnesium-Halide Complex or more specifically as a Magnesium-Aluminum Chloride Complex (MACC) solution. The product of this reaction enables reversible, facile electrochemical plating and stripping of Mg-ions onto an electrode without the use of organometallic reagents for the first time.

The non-aqueous electrolyte solution including MACC can employ MgCl₂ and AlCl₃ over a range of proportions to provide a range of Mg:Al ratios. In certain embodiments, the Mg:Al ratio is in the range of 1:1 to 5:1 with preferable being 4:1, 3:1, 2:1 or any ratio between. For example, any non-whole number ratio may also be used.

Although MgCl₂ is generally regarded as insoluble or poorly soluble in many organic solvents, it has been surprisingly demonstrated that non-aqueous electrolyte solutions including magnesium chloride complexes and in particular using MACC are possible, wherein the Mg molarity, e.g., concentration, ranging up to 1 M or 2 M, and for example at about 0.25 to about 0.5 M for Mg.

Other Lewis acids may be used; in preferred embodiments the Lewis acid meets the requirements of electrochemical stability throughout the window of cell operation. Such Lewis acids can be inorganic, that is, they do not contain any metal-organic bonds. Exemplary Lewis acids include AlCl₃, AlBr₃, AlF₃, AlI₃, PCl₃, PF₃, PBr₃, PI₃, BCl₃, BF₃, BBr₃, BI₃, SbCl₃, SbF₃, SbBr₃, SbI₃.

A variety of organic solvents are suitable for use in the electrolyte of the present invention. Suitable solvent(s) provide appreciable solubility to the Mg salt complex. Further, suitable solvent(s) do not electrochemically oxidize prior to the salt complex, or reduce above the Mg plating potential. Exemplary solvents include ethers, organic carbonates, lactones, ketones, nitriles, ionic liquids, aliphatic and aromatic hydrocarbon solvents and organic nitro solvents. More specifically, suitable solvents include THF, 2-methyl THF, dimethoxyethane, diglyme, ethyl diglyme, butyl diglyme triglyme, tetraglyme, diethoxyethane, diethylether, proglyme, dimethylsulfoxide, dimethylsulfite, sulfolane, acetonitrile, hexane, toluene, nitromethane, 1-3 dioxalane, 1-4 dioxane, trimethyl phosphate, tri-ethyl phosphate, hexa-methyl-phosphoramide (HMPA), N,N-propyl-methyl-pyrrolidinium-bis(trifluoromethylsulfonyl)imide (P13-TFSI), N,N-propyl-methyl-pyrrolidinium-diacetamide (P13-DCA), propyl-methyl-pyrrolidinium-bis(fluorosulfonyl)imide (P13-FSI), ethyl-dimethyl-propyl-ammonium-bis(trifluoromethylsulfonyl)imide (PDEA-TFSI), and 1-(methoxyethyl)-1-methylpiperidinium-bis(trifluoromethylsulfonyl)imide (MOEMPP-TFSI), ionic liquids, or combinations of any or all solvents listed with each other or a solvent not listed.

In one or more embodiments, the solvent is THF or dimethoxyethane for a solution containing the reaction product(s) of MgCl₂ and AlCl₃; the electrolyte assists in the reversible, electrochemical deposition and stripping of Mg when used in an electrochemical cell or plating bath.

While the concept of the above reaction results from effort to surpass the high voltage limitations of all previous organometallic-based electrolytic solutions, it is surprising to someone with expertise in the field that the invention described herein works for at least the following reasons:
1) The only electrolyte solutions proven to reversibly electrodeposit Mg metal at or near room temperature required the utilization of Grignard reagent, or another organometallic reagent with metal-organic bonds. Previously, no entirely inorganic salt solutions had ever shown such behavior;
2) The low solubility of MgCl₂ in various solvents steered others to conclude co-dissolution and reaction was not favorable, or even possible;
3) MgCl₂ is a chemically inert inorganic magnesium salt. It does not dissociate in solutions based on aprotic organic solvents to appreciable extent and displays little to no conductivity in solution. Furthermore, MgCl₂ alone is electrochemically inactive in such solutions, enabling no Mg deposition, dissolution or intercalation.

The magnesium electrolyte salt can be prepared by combining a source of magnesium, e.g., a magnesium halide, and a source of Z, e.g., a halide based on the metal Z in the electrolyte solvent with stirring and heating. Exemplary reaction times include 1, 5, 10, 12, 24, and 48 hours; exemplary reaction temperatures include greater than or equal to 20 degrees Celsius. Heating under inert atmosphere is preferred to avoid water contamination and formation of oxide species.

In some embodiments, it is preferable to condition the solution prior to use in an electrochemical cell, by elimination or mitigation of harmful species inevitably found in the raw materials and/or the as-prepared solution. In some embodiments, additives are provided in the electrolyte to mitigate the deleterious species, without the production of side reaction or unwanted, harmful chemicals. Water, oxygen, and peroxide(s) are non-limiting examples of deleterious species.

Conditioning is accomplished by control of variables including, but not limited to, Mg:Al ratio, constituent molarity, solvent choice, precursor and solvent purity, impurity removal, reaction temperature, time, mixing, and electrochemical conditions could yield the first solution containing an all inorganic salt capable of reversible deposition of Mg. The electrolyte can be conditioned using a variety of processes, including physical, chemical and electrochemical process. The process of conditioning includes the following non-limiting examples:
1) Using Al as an example for Z, physical processes that enable a high degree of Mg complex formation and removal of deleterious species/impurities including: heating, freezing, distillation, maintaining an Mg:Al ratio between 1:1 and 5:1, maintaining molarities that saturate the solution, etc. In some embodiments, the electrolyte solution is heated to help the dissolution of the Mg salt and the Lewis acids. In some embodiments, the Mg:Al ratio is adjusted so that a saturated electrolyte solution with high concentration of the electrolytically active Mg salt complex is obtained. In some specific embodiments, the Mg:Al ratio is 1:1, 2:1, 3:1, 4:1, or 5:1. Similarly, in the case where Z is a metal other than Al, the Mg:Z ratio can be adjusted to result in a high concentration of electrolytically active Mg salt complex. Non-limiting examples of the Mg:Z ratios include those between 0.5:1 and 5:1;
2) Chemical processes in order to remove deleterious species such as addition of minute quantities of proton/water scavengers, such as Grignard's, organoaluminum, molecular sieves, gamma-alumina, silica, Magnesium metal, etc.;
3) Electrochemical processes like potentiostatic, potentiodynamic or galvanostatic electrolysis that enable a high degree of Mg complex formation and removal of deleterious species/impurities. This can be accomplished at reducing or oxidizing potentials, which reduce or oxidize deleterious species and/or drive the reaction of reactants to products. It can be exercised with inert electrodes, sacrificial electrodes, like Mg or, within a complete cell, with an auxiliary electrode or with the cathode serving as the working electrode. In some specific embodiments, the electrolyte is subjected to multiple cycles of potentiostatic, potentiodynamic or galvanostatic electrolysis. In some specific embodiments, the electrolyte is potentiostatically polarized for 5 cycles, 10 cycles, 15 cycles, 20 cycles, or 30 cycles.

In one or more embodiments, the electrolyte salt solution is conditioned to improve the electrochemical properties through electrochemical polarization.

In one or more embodiments, the electrolyte salt solution is conditioned to improve the electrochemical properties by reacting with insoluble active metals Mg, Al, Ca, Li, Na, K., and/or reacting with insoluble acids/bases, adsorbing agents such as molecular sieves, CaH₂, alumina, silica, MgCO₃, etc.

In one or more embodiments, the electrolyte salt solution is conditioned improve the electrochemical properties by providing additives to scavenge contaminants such as organo-Mg, organo-Al, organo-B, organometallics, trace water, oxygen and CO₂, and protic contaminants.

As described above, the electrochemical window of a cell with an electrolyte as described herein and an appropriate anode-cathode pair is 2.9-3.1 volts, such that the cell can be operated in a stable, reversible fashion at 2.0-2.6 volts without decomposition of the electrolyte.

In one or more embodiments, an electrochemical cell is provided including and electrolyte having at least one organic solvent and at least one electrolytically active, soluble, inorganic Magnesium (Mg) salt complex represented by the formula: MgₙZX_{3+(2*n)}, in which Z is selected from a group consisting of aluminum, boron, phosphorus, titanium, iron, and antimony; X is a halogen (I, Br, Cl, F or mixture thereof) and n=1-5. the electrochemical cell includes a metal anode and an intercalation cathode.

In one or more embodiments, an electrochemical cell is provided including an electrolyte having at least one electrolytically active, soluble, inorganic Magnesium (Mg) salt complex represented by the formula MgₐZ_{b}X_{c} wherein a, b, and c are selected to maintain neutral charge of the molecule, and Z and X are selected such that Z and X form a Lewis Acid; and 1≦a≦10, 1≦b≦10, and 2≦c≦30. The electrochemical cell includes a metal anode and an intercalation cathode.

In one or more embodiments, a battery includes the electrolyte according to the present invention, a magnesium metal anode and a magnesium insertion compound cathode.

In one or more embodiments, the magnesium insertion-compound cathode includes a magnesium-Chevrel intercalation cathode of the formula, Mo₆S₈.

The electrolyte composition of the present invention includes an organic solvent and electrochemically-active, soluble, inorganic salt of the formula MgₙZX_{3+(2*n)}, in which Z is selected from a group consisting of aluminum, boron, phosphorus, titanium, iron, and antimony; X is a halogen (I, Br, Cl, F or mixture thereof) and n=1-5. Inorganic salts of this form may, in certain cases, be combined with compatible organometallic salts or with compatible inorganic salts of other forms.

The non-aqueous electrolyte solution including Mg₂Cl₃-TFSI can employ MgCl₂ and Mg[N(CF₃SO₂)₂]₂ over a range of proportions to provide formation of Mg²⁺, Mg₂Cl₃⁺, MgCl⁺ and MgCl₂, or mixtures thereof. In certain embodiments, the MgCl₂:Mg(TFSI)₂ ratio is in the ratio of 1:4 to 5:1 with preferable ratios being 4:1, 3:1, 2:1 or any ratio between. In certain embodiments, the MgCl₂:Mg(TFSI)₂ ratio is in the range of 1:1 to 5:1 with preferable ratios being 4:1, 3:1, 2:1 or any ratio between. For example, any non-whole number proportion in the range from 5:1 to 1:1 may also be used. In one or more embodiments, the electrolyte salt complex can have an Mg concentration of greater than 0.1 M for Mg. In one or more embodiments, the electrolyte salt complex can have a Mg concentration of at about 0.1 M to about 0.5 M for Mg.

In one or more embodiments a non-aqueous electrolyte for use in an electrochemical cell includes at least one organic solvent and at least one electrolytically active, soluble, magnesium (Mg) salt complex represented by the formula Mgₙ₊₁Cl_{(2*n)}Z₂, in which Z is selected from the group of monovalent negative complex ions described in Table I or mixtures thereof; and n is in the range from one to four. The electrolyte salt complex can be used at any concentration; however, in certain embodiments, the Mg molarity, e.g., concentration, ranges up to 1 M. In one or more embodiments, the electrolyte salt complex is expected to have a Mg concentration of about 0.25 to about 0.5 M. In a few additional embodiments, the electrolyte salt complex is expected to have a Mg concentration of greater than 1 M.

Surprisingly, it has been proposed that the voltage at which the anodic electrolyte decomposition occurs is set by the breaking of metal-organic bonds. In addition, chlorinated anions such as tetrachloroaluminate limit the anodic stability to ˜3 V vs. Mg/Mg²⁺. In order to surpass the energy density limitations of current state-of-the-art one needs an electrolyte capable of higher voltage stability while maintaining the ability to electrochemically deposit and strip Mg-ions in facile, reversible manner.

While not being bound by any particular mode of operation, it is hypothesized that the capability for reversible Mg deposition is accomplished via the formation of MgCl⁺ and/or Mg₂Cl₃⁺ clusters in solution. Cationic species using other halides, such as MgBr⁺ and/or Mg₂Br₃⁺ clusters, and MgF⁺ and/or Mg₂F₃⁺ clusters may also be suitable for reversible Mg deposition.

Although MgCl₂ is generally regarded as insoluble or poorly soluble in many organic solvents, it is possible to prepare non-aqueous electrolyte solution including magnesium chloride complexes and in particular using Mg₂Cl₃-TFSI, wherein the Mg molarity, e.g., concentration, ranging up to 2 M, and for example at about 0.1 to about 0.5 M for Mg.

Other anions with high anodic stability may be used, as long as they meet the requirements of electrochemical stability throughout the voltage window of cell operation.

A variety of organic solvents are suitable for use in the electrolyte of the present invention. The organic solvents can be used alone or in combination. Whether a solvent comprises a single organic composition or a plurality of organic compositions, for the purposes of further exposition, the organic solvent will be referred to as “the solvent” in the singular. In order to provide for the reversible dissolution and plating of Mg, the solvent advantageously should provide appreciable solubility by coordination of the constituent inorganic salts of Mg. Further the solvent preferably should not reduce above the Mg plating potential, so as to form products which inhibit migration of Mg from solution to the electrode surface. In various embodiments, suitable solvents include ethers and tertiary amines, and may also include organic carbonates, lactones, ketones, glymes, nitriles, ionic liquids, aliphatic and aromatic hydrocarbon solvents and organic nitro solvents. More specifically, suitable solvents include THF, 2-methyl THF, dimethoxyethane, diglyme, triglyme, tetraglyme, diethoxyethane, diethylether, proglyme, ethyl diglyme, butyl diglyme, dimethylsulfoxide, dimethylsulfite, sulfolane, ethyl methyl sulfone, acetonitrile, hexane, toluene, nitromethane, 1-3 dioxalane, 1-3 dioxane, 1-4 dioxane, trimethyl phosphate, tri-ethyl phosphate, hexa-methyl-phosphoramide (HMPA), N,N-propyl-methyl-pyrrolidinium-bis(trifluoromethylsulfonyl)imide (P13-TFSI), N,N-propyl-methyl-pyrrolidinium-diacetamide (P13-DCA), propyl-methyl-pyrrolidinium-bis(fluorosulfonyl)imide (P13-FSI),ethyl-dimethyl-propyl-ammonium-bis(trifluoromethylsulfonyl)imide (PDEA-TFSI), and 1-(methoxyethyl)-1-methylpiperidinium-bis(trifluoromethylsulfonyl)imide (MOEMPP-TFSI).

In one or more embodiments, the solvent that enables reversible, electrochemical deposition and stripping of Mg from a solution containing the reaction product(s) of MgCl₂ and Mg(TFSI)₂ is a THF, dimethoxyethane, ethyl diglyme, butyl diglyme, or a mixture thereof.

The reaction described above is motivated by an effort to surpass the high voltage and safety limitations of previous organometallic-based electrolytic solutions. However, it would appear that the result observed comes as a surprise to one of ordinary skill in the relevant art, for three reasons: First, electrolyte solutions previously shown to reversibly electrodeposit Mg metal at or near room temperature generally required the utilization of Grignard reagent, or another organometallic reagent with metal-organic bonds. One practiced in the art will recognize that previous attempts to utilize inorganic magnesium salts failed to enable substantial reversibility of magnesium deposition with high Coulombic efficiency and low overpotential, but instead resulted in decomposition of the solution components. Second, the low solubility of MgCl₂ in various solvents led others to conclude co-dissolution and reaction was not favorable. And third, MgCl₂ is a chemically inert inorganic magnesium salt. It does not dissociate in based on aprotic organic solvents to appreciable extent and displays little to no conductivity in ethereal solution. Furthermore, MgCl₂ alone is electrochemically inactive in such ethereal solutions, enabling only negligible Mg deposition, dissolution or intercalation.

The magnesium electrolyte salt can be prepared by combining a source of magnesium cation, e.g., a magnesium halide, and a source of an anion stable at high voltage, based on the anion Z in the electrolyte solvent with stirring and heating. Exemplary reaction times include 1, 5, 10, 12, 24, 48 and 72 hours; exemplary reaction temperatures include between 20 and 50 degrees Celsius. Heating under inert or reduced atmosphere is preferred to avoid water contamination and formation of oxide species.

In some embodiments, it is preferable to condition the solution prior to use in an electrochemical cell, by elimination or mitigation of harmful species inevitable found in the raw materials and/or the as-prepared solution. In some embodiments, additives are provided in the electrolyte to mitigate the deleterious species, without the production of side reaction or unwanted, harmful chemicals. Water, oxygen, and peroxide(s) are non-limiting examples of deleterious species.

### Solution Conditioning

Solution conditioning is accomplished by control of variables including, but not limited to, cation:anion ratio, constituent molarity, choice of solvent or solvents, precursor and solvent purity, impurity removal, reaction temperature, time, mixing, and electrochemical conditions can yield a solution containing an all inorganic salt capable of reversible deposition of Mg. The electrolyte can be conditioned using a variety of processes, including physical, chemical and electrochemical process.

The process of conditioning includes the following non-limiting examples.

Physical processes that enable a high degree of Mg complex formation and removal of deleterious species/impurities including: heating, freezing, distillation, maintaining an MgCl₂:MgZ₂ ratio between 1:1 and 4:1, maintaining molarities that saturate the solution, etc. In some embodiments, the electrolyte solution is heated to help the dissolution of the Mg salts. In some embodiments, the MgCl₂:MgZ₂ ratio is adjusted so that a saturated electrolyte solution with high concentration of the electrolytically active Mg salt complex is obtained. In some specific embodiments, the MgCl₂:MgZ₂ ratio is 1:1, 2:1, 3:1, or 4:1 or any non-integer value in between. Similarly, in the case where Z is an anion other than bis(trifluoromethylsulfonyl)imide, the MgCl₂:MgZ₂ ratio can be adjusted to result in a high concentration of electrolytically active Mg salt complex. Non-limiting examples of the MgCl₂:MgZ₂ with any ratio between 4:1 and 1:4. Non-limiting examples of the MgCl2:MgZ2 include 1:1, 2:1, 3:1, and 4:1.

Chemical processes in order to remove deleterious species such as addition of minute quantities of proton/water scavengers, such as Grignard reagents, AlCl₃, organoaluminum, molecular sieves, gamma-alumina, silica, Magnesium metal, etc.

Electrochemical processes like potentiostatic, potentiodynamic or galvanostatic electrolysis that enable a high degree of Mg complex formation and removal of deleterious species/impurities. This can be accomplished at reducing or oxidizing potentials, which reduce or oxidize deleterious species and/or drive the reaction of reactants to products. It can be exercised with inert electrodes, sacrificial electrodes, like Mg or, within a complete cell, with an auxiliary electrode or with the cathode serving as the working electrode. In some specific embodiments, the electrolyte is subjected to multiple cycles of potentiostatic, potentiodynamic or galvanostatic electrolysis. In some specific embodiments, the electrolyte is potentiostatically polarized for 5 cycles, 10 cycles, 15 cycles, 20 cycles, or 30 cycles.

In one or more embodiments, the electrolyte salt solution is conditioned to improve the electrochemical properties through electrochemical polarization.

In one or more embodiments, the electrolyte salt solution is conditioned to improve the electrochemical properties by reacting with insoluble active metals, such as metallic Mg, Al, Ca, Li, Na, or K, and/or reacting with insoluble acids/bases, and by being exposed to adsorbing agents such as molecular sieves, CaH₂, alumina, silica, MgCO₃, and similar absorptive materials.

In one or more embodiments, the electrolyte salt solution is conditioned to improve the electrochemical properties by providing additives to scavenge contaminants. The contaminants that can be scavenged include but are not limited to organo-Mg compounds, organo-Al compounds, organo-B compounds, organometallics, trace water, oxygen, CO₂, and protic contaminants such as acids.

As described above, the electrochemical window of a cell with an electrolyte as described herein and an appropriate anode-cathode pair has been observed to be 3.5-3.6 volts.

It is expected that the electrolytic solutions described and contemplated herein can be used in such devices as electrochemical cells, secondary (e.g., rechargeable) batteries, and energy storage devices that include, in addition to the electrolyte, an anode and a cathode. In some embodiments, an electrochemical cell can include a metal anode and an intercalation cathode.

In one or more embodiments, a secondary battery includes the electrolyte according to the present invention, a magnesium metal anode and a magnesium insertion compound cathode.

In one or more embodiments, a secondary battery includes the electrolyte according to the present invention, a magnesium metal anode and a conversion, or displacement compound cathode.

In one or more embodiments, the magnesium insertion-compound cathode includes a magnesium-Chevrel intercalation cathode of the formula, Mo₆S₈.

The electrolyte composition of the present invention includes an organic solvent and electrochemically-active, soluble, inorganic salt complex represented by the formula Mgₙ₊₁Cl_{(2*n)}Z_{2.}, in which Z is selected from the compounds described in Table I or mixtures thereof; and n is in the range from one to four.

Inorganic salts of this form may, in certain cases, be combined with compatible organometallic salts or with compatible inorganic salts of other forms.

Intercalation cathodes used in conjunction with the electrolyte according to the present invention preferably include transition metal oxides, transition metal oxo-anions, chalcogenides, and halogenides and combinations thereof. Non-limiting examples of positive electrode active material for the Mg battery include Chevrel phase Mo₆S₈, MnO₂, CuS, Cu₂S, Ag₂S, CrS₂, VOPO₄, layered structure compounds such as TiS₂, V₂O₅, MgVO₃, MoS₂, MgV₂O₅, MoO₃, Spinel structured compounds such as CuCr₂S₄, MgCr₂S₄, MgMn₂O₄, MgNiMnO₄, Mg₂MnO₄, NASICON structured compounds such as MgFe₂(PO₄)₃ and MgV₂(PO₄)₃, Olivine structured compounds such as MgMnSiO₄ and MgFe₂(PO₄)₂, Tavorite structured compounds such as Mg_{0.5}VPO₄F, pyrophosphates such as TiP₂O₇ and VP₂O₇, and fluorides such as MgMnF₄ and FeF₃.

In some embodiments, the positive electrode layer further comprises an electronically conductive additive. Non-limiting examples of electronically conductive additives include carbon black, Super P, Super C65, Ensaco black, Ketjen black, acetylene black, synthetic graphite such as Timrex SFG-6, Timrex SFG-15, Timrex SFG-44, Timrex KS-6, Timrex KS-15, Timrex KS-44, natural flake graphite, carbon nanotubes, fullerenes, hard carbon, or mesocarbon microbeads.

In some embodiments, the positive electrode layer further comprises a polymer binder. Non-limiting examples of polymer binders include poly-vinylidene fluoride (PVdF), poly(vinylidene fluoride-co-hexafluoropropene) (PVdF-HFP), Polytetrafluoroethylene (PTFE), Kynar Flex 2801, Kynar Powerflex LBG, and Kynar HSV 900, or Teflon.

Negative electrodes used in conjunction with the present invention comprise a negative electrode active material that can accept Mg-ions. Non-limiting examples of negative electrode active material for the Mg battery include Mg, Mg alloys such as AZ31, AZ61, AZ63, AZ80, AZ81, AZ91, AM50, AM60, Elektron 675, ZK51, ZK60, ZK61, ZC63, M1A, ZC71, Elektron 21, Elektron 675, Elektron, Magnox, or insertion materials such as Anatase TiO2, rutile TiO2, Mo₆S₈, FeS₂, TiS₂, MoS₂.

In some embodiments, the negative electrode layer further comprises an electronically conductive additive. Non-limiting examples of electronically conductive additives include carbon black, Super P, Super C65, Ensaco black, Ketjen black, acetylene black, synthetic graphite such as Timrex SFG-6, Timrex SFG-15, Timrex SFG-44, Timrex KS-6, Timrex KS-15, Timrex KS-44, natural flake graphite, carbon nanotubes, fullerenes, hard carbon, or mesocarbon microbeads.

In some embodiments, the negative electrode layer further comprises a polymer binder. Non-limiting examples of polymer binders include poly-vinylidene fluoride (PVdF), poly(vinylidene fluoride-co-hexafluoropropene) (PVdF-HFP), Polytetrafluoroethylene (PTFE), Kynar Flex 2801, Kynar Powerflex LBG, and Kynar HSV 900, or Teflon.

In some embodiments, the Mg battery used in conjunction with the electrolyte described herein comprises a positive electrode current collector comprising carbonaceous material, or a current collector comprising a metal substrate coated with an over-layer to prevent corrosion in the electrolyte. In some embodiments, the Mg battery described herein comprises a negative electrode current collector comprising carbonaceous material. In other embodiments, the Mg battery described herein comprises positive and negative electrode current collectors comprising carbonaceous material.

In some embodiments, the Mg battery disclosed herein is a button or coin cell battery consisting of a stack of negative electrode, porous polypropylene or glass fiber separator, and positive electrode disks sit in a can base onto which the can lid is crimped. In other embodiments, the Mg battery used in conjunction with the electrolyte disclosed herein is a stacked cell battery. In other embodiments, the Mg battery disclosed herein is a prismatic, or pouch, cell consisting of one or more stacks of negative electrode, porous polypropylene or glass fiber separator, and positive electrode sandwiched between current collectors wherein one or both current collectors comprise carbonaceous materials, or a metal substrate coated with an over-layer to prevent corrosion in the electrolyte. The stack(s) are folded within a polymer coated aluminum foil pouch, vacuum and heat dried, filled with electrolyte, and vacuum and heat sealed. In other embodiments, the Mg battery disclosed herein is a prismatic, or pouch, bi-cell consisting of one or more stacks of a positive electrode which is coated with active material on both sides and wrapped in porous polypropylene or glass fiber separator, and a negative electrode folded around the positive electrode wherein one or both current collectors comprise carbonaceous materials. The stack(s) are folded within a polymer coated aluminum foil pouch, dried under heat and/or vacuum, filled with electrolyte, and vacuum and heat sealed. In some embodiments of the prismatic or pouch cells used in conjunction with the electrolyte described herein, an additional tab composed of a metal foil or carbonaceous material of the same kind as current collectors described herein, is affixed to the current collector by laser or ultrasonic welding, adhesive, or mechanical contact, in order to connect the electrodes to the device outside the packaging.

In other embodiments, the Mg battery used in conjunction with the electrolyte disclosed herein is a wound or cylindrical cell consisting of wound layers of one or more stacks of a positive electrode which is coated with active material on one or both sides, sandwiched between layers of porous polypropylene or glass fiber separator, and a negative electrode wherein one or both current collectors comprise carbonaceous materials. The stack(s) are wound into cylindrical roll, inserted into the can, dried under heat and/or vacuum, filled with electrolyte, and vacuum and welded shut. In some embodiments of the cylindrical cells described herein, an additional tab composed of a metal foil or carbonaceous material of the same kind as current collectors described herein, is affixed to the current collector by laser or ultrasonic welding, adhesive, or mechanical contact, in order to connect the electrodes to the device outside the packaging.

The invention is illustrated by way of the following examples, which are presented by way of illustration only and are not intended to be limiting of the invention.

We now provide example electrolytes that are expected to be suitable for Mg-based secondary battery systems. In particular, materials contemplated for use in the electrolytes of the invention are compared to those containing >200 ppm total water content

### Example 1

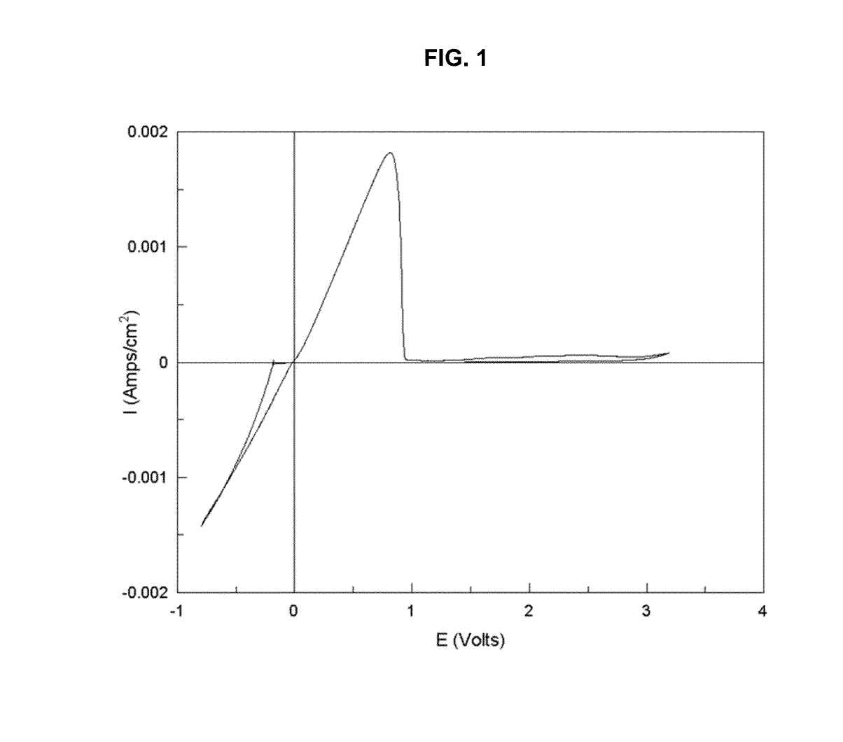

FIG. 1 is a graph displaying a typical cyclic voltammogram of the all-inorganic salt Magnesium Aluminum Chloride complex. Solutions utilize tetrahydrofuran (THF) as the solvent and Platinum as the working electrode while Magnesium serves as both the auxiliary and reference electrodes.

The data depicted in FIG. 1 shows the potentiodynamic behavior of Mg₂AlCl₇ complex inorganic salt obtained with THF solution from the reaction of 2MgCl₂+1AlCl₃. The peak displaying maximum current density at −1 V is due to the deposition of magnesium metal while the peak with maximum current density at about 0.3 V is attributed to the subsequent electrochemical dissolution of the magnesium metal. The electrochemical window obtained with this system exceeds 3.1 V vs Mg/Mg²⁺. It is clearly evident from the cyclic voltammogram that the process of magnesium deposition and dissolution is fully reversible.

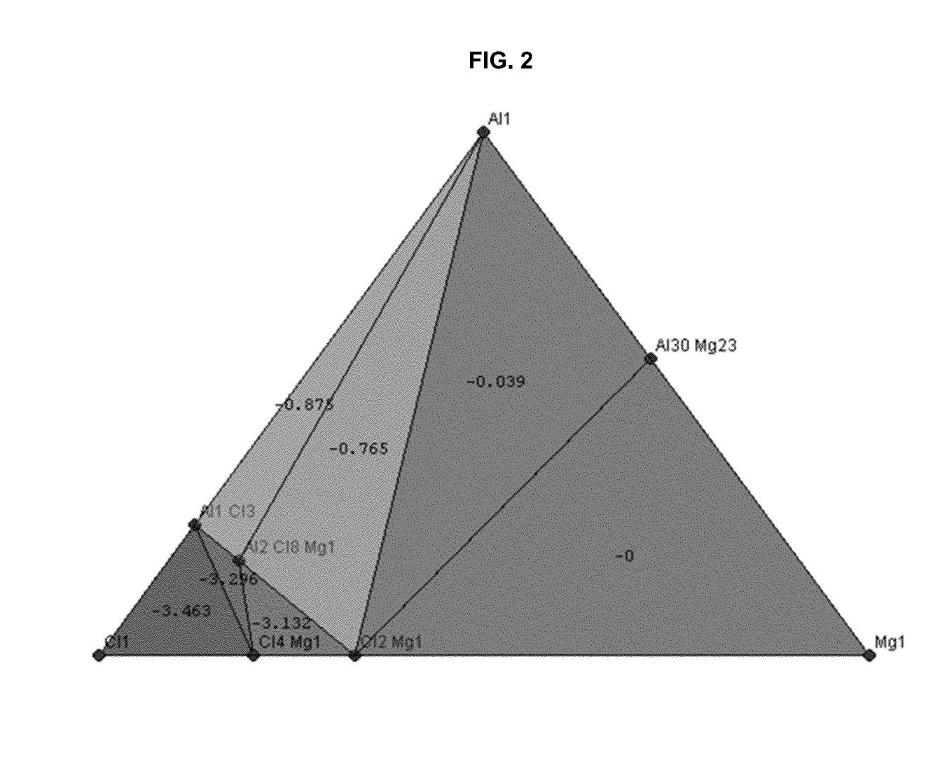

FIG. 2 depicts the Mg—Al—Cl ternary phase diagram derived from the ab initio calculated energies of compounds within that system. Each point in the diagram represents a thermodynamically stable compound (e.g., Mg, MgCl₂, MgAl₂Cl₈ etc.) and the space within each triangular plane represents compositional space wherein a mixture of the three vertex compounds is thermodynamically favored over a single ternary compound within that region up until the voltage vs. Mg/Mg²⁺ indicated within that triangle. The phase diagram indicates that compounds existing along the tie line between MgCl₂ and AlCl₃, such as MgAl₂Cl₈, will oxidize when the voltage is >3.1-3.3 V vs. Mg/Mg²⁺. This result corroborates the cyclic voltammogram depicted in FIG. 1, which suggests 3.1 V vs. Mg/Mg²⁺ is the limit of oxidative stability for Magnesium Aluminum Chloride Complexes resulting from the reaction of 2MgCl₂+1AlCl₃. Furthermore it is important to note MgCl₂ is in direct equilibrium with Mg metal because it can be a soluble species and will not disproportionate into undesirable products in the presence of Mg metal. Similar observations can be made for reaction of MgCl₂ with any of the following: BCl₃, PCl₃, SbCl₃, PCl₃.

### Example 2

In a typical preparation of an electrochemically active MACC solution such as 0.267 M Mg₂AlCl₇, one may undertake the following reaction:

2MgCl₂+1AlCl₃→Mg₂AlCl₇,

by placing both ˜0.508 g MgCl₂ powder (99.99%) and ˜0.356 AlCl₃ (99.999%) into a single glass container with a stir bar under inert atmosphere. Thereafter add 20.0 ml of tetrahydrofuran (THF, anhydrous <20 ppm H₂O) and stir vigorously because the initial dissolution is exothermic in nature. Subsequently stir and heat to >30.0 degrees Celsius for minimum of one hour after which solution may be returned to room temperature. The resulting solution is clear to light yellow or brown color with no precipitation. In some embodiments it is preferable to let the final solution sit over Mg metal powder in order to condition the solution for improved electrochemical response by reducing residual water and other impurities.

In a typical preparation of an electrochemically active MACC solution such as 0.4 M MgAlCl₅, one may undertake the following reaction:

1MgCl₂+1AlCl₃→MgAlCl₅,

by placing both ˜1.1424 g MgCl₂ powder (99.99%) and ˜1.6002 AlCl₃ (99.999%) into a single glass container with a stir bar under inert atmosphere. Thereafter add 30.0 ml of 1,2-dimethoxymethane (DME, anhydrous <20 ppm H₂O) and stir vigorously because the initial dissolution is exothermic in nature. Subsequently stir and heat to ≧70.0 degrees Celsius for minimum of several hours after which solution may be returned to room temperature. The resulting solution is clear with no precipitation. In some embodiments it is preferable to let the final solution sit over Mg metal powder in order to condition the solution for improved electrochemical response by reducing residual water and other impurities.

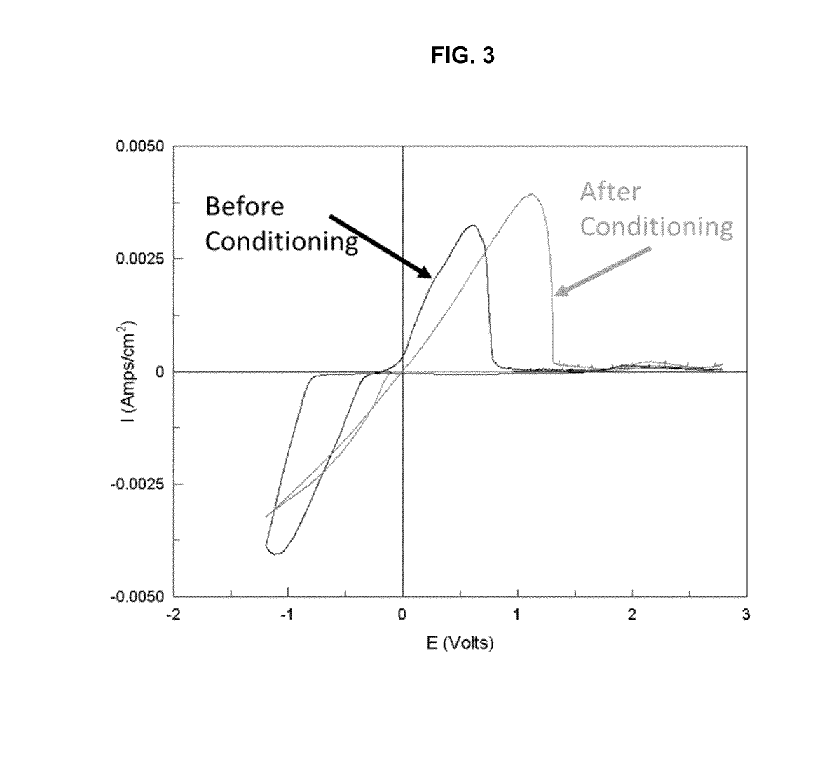

FIG. 3 depicts representative cyclic voltammogram of the all-inorganic Magnesium Aluminum Chloride complex dissolved in tetrahydrofuran (THF) using a platinum working electrode, and Mg for the counter and reference electrodes. The voltammogram depicted in black illustrates the significant hysteresis between Mg plating and stripping of the as produced solution while the voltammogram depicted in grey depicts the same solution with significantly improved plating ability due to electrochemical conditioning by galvanostatic and/or potentiostatic polarization. The electrolyte solution was potentiostatically polarized within the same voltage window for 15 cycles. The cyclic voltammetry utilized 25 mV/s scan rate and a platinum working electrode, and Mg for the counter and reference electrodes.

### Example 3

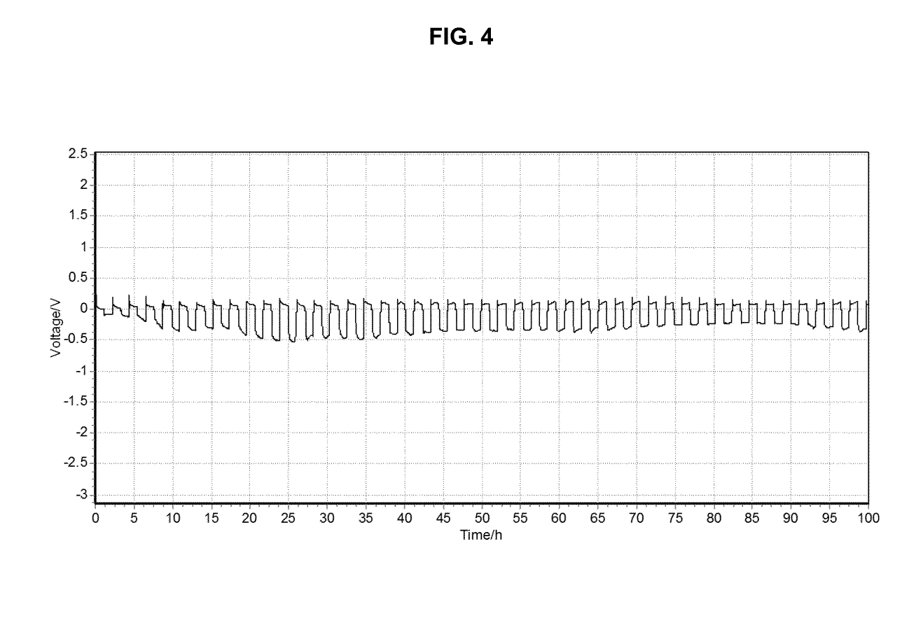

Referring now to FIG. 4, which displays a graph of the potential response of resulting during chronopotentiometry experiments carried out with Mg₂AlCl₇ complex inorganic salt obtained with THF solution from the reaction of 2MgCl₂+1AlCl₃. This test utilizes Magnesium electrodes in a symmetric cell fashion and an applied current of 0.1 mA/cm2, which switches polarity every one hour. The overpotential for dissolution is quite small (˜0.05 V vs. Mg) throughout the test while the overpotential for deposition varies between −0.1 and −0.5 V vs. Mg metal. The results suggest the overpotential for Mg deposition is at most −0.5 V vs. Mg/Mg²⁺, but that the mean within the 100 hour period is about −0.25 V vs. Mg/Mg²⁺.

### Example 4

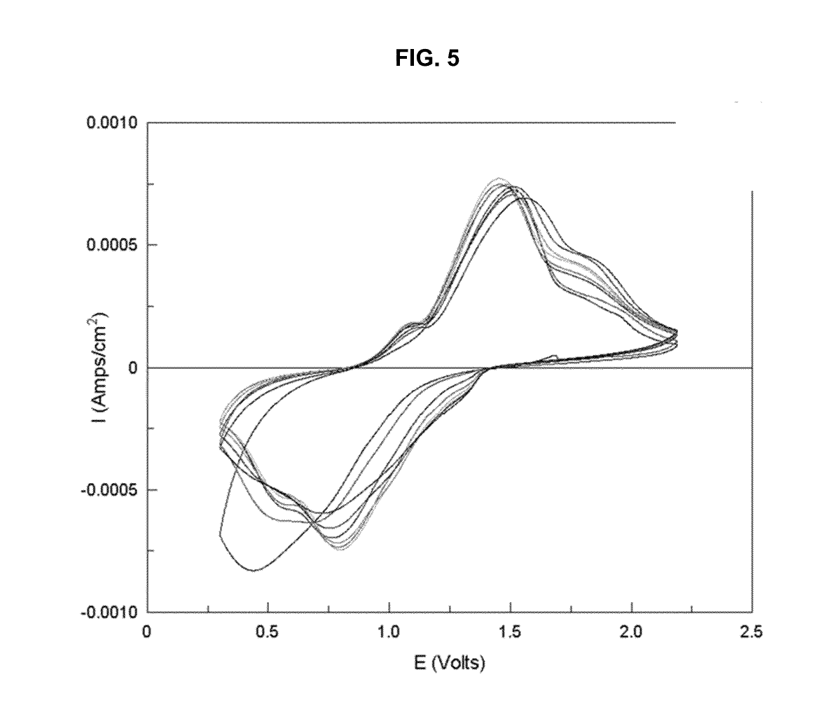

An electrochemical cell was prepared consisting of a Chevrel-phase cathode, a magnesium metal anode, and an electrolyte containing Magnesium Aluminum Chloride complex salt. The cathode was made from a mixture of copper-leached Chevrel-phase material containing 10 weight-% carbon black and 10 weight-% PVdF as a binder, spread on Pt mesh current collector. The electrolyte solution containing Mg₃AlCl₉, was prepared from the reaction of 3MgCl₂+1AlCl₃ in THF solution. The anode and reference electrode was composed of pure magnesium metal. The glass cell was filled under inert atmosphere. FIG. 5 depicts a graph of the results from cyclic voltammetry carried out on this cell. A scan rate of 0.1 mV/s was applied, so as not to limit the current response by the rate of Mg solid-state diffusion into Chevrel. The current response of the voltammogram corresponds with ˜80 mAh/g over eight charge/discharge cycles at voltages comparable to those observed in prior art with organo-Mg complex salt solutions.

### Example 5

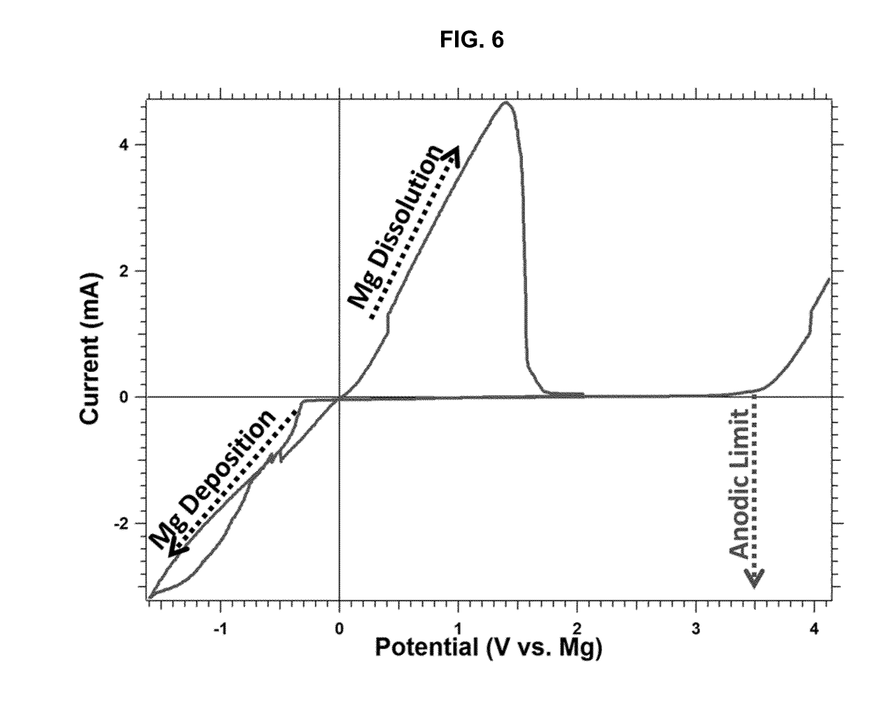

FIG. 6 is a graph displaying a typical cyclic voltammogram of the Mg₂Cl₃-TFSI complex resulting from reaction of MgCl₂ and Mg(TFSI)₂. Solutions utilize a mixture of 1,2-dimethoxymethane (DME) and tetrahydrofuran (THF) as the solvent and Platinum as the working electrode while Magnesium serves as both the auxiliary and reference electrodes.

The data depicted in FIG. 6 shows the potentiodynamic behavior of Mg₂Cl₃-TFSI complex salt obtained with DME/THF solution from the reaction of 3MgCl₂+Mg[N(CF₃SO₂)₂]₂. The experiment utilized a scan rate of 25 mV/s, a platinum working electrode, and Mg for the counter and reference electrodes. The anodic stability of the solution is about 3.5 V vs. the onset of Mg dissolution. This is significantly higher than previous electrolytic solutions capable of reversibly plating Mg. The peak displaying maximum current density at −1.3 V is attributed to the deposition of magnesium metal while the peak with maximum current density at about 1.8 V is attributed to the subsequent electrochemical dissolution of the magnesium metal. The electrochemical window obtained with this system exceeds 3.5 V vs. the onset of Mg dissolution. Mg₂Cl₃-TFSI is one preferred embodiment of a complex salt useful in an electrolyte according to principles of the invention.

### Example 6

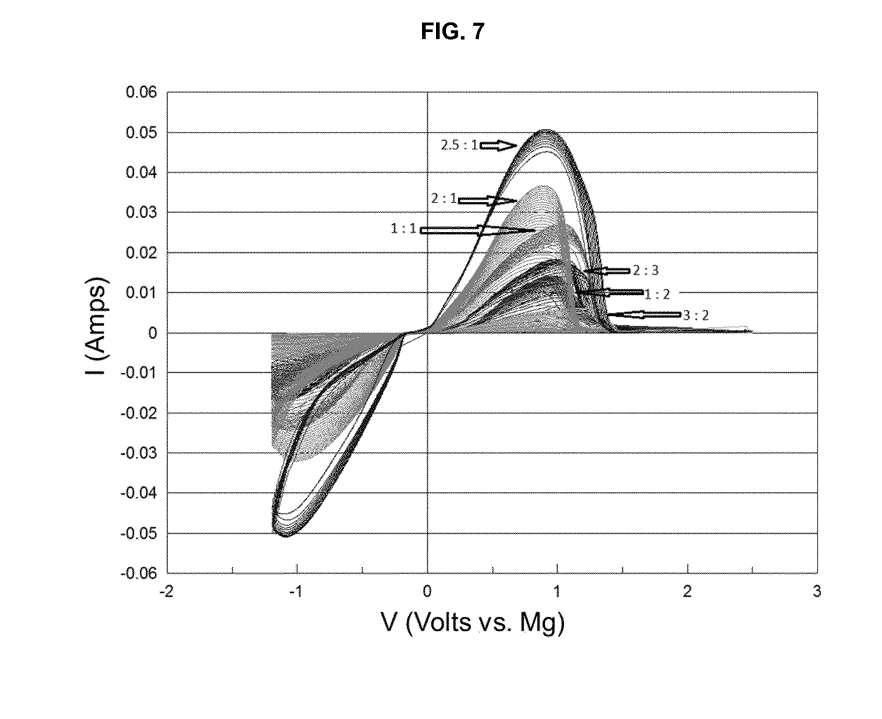

FIG. 7 is a graph displaying a typical cyclic voltammograms of the inorganic magnesium salt complex resulting from reaction of MgCl₂ and Mg(TFSI)₂ when the mole ratio is varied between the two reactants. Solutions utilize 1,2-dimethoxymethane (DME) as the solvent. The experiment utilized a scan rate of 25 mV/s, a platinum working electrode, and Mg for the counter and reference electrodes. The mole ratio of MgCl₂ to Mg(TFSI)₂ ranges from 1:2 to 2.5:1 in this salt solution. A high degree of reversibility and Coulombic efficiency is present in each composition depicted in FIG. 2. Furthermore the Mg deposition and stripping occurs with low overpotential. Table 4 below demonstrates that solutions of mole ratio for MgCl₂ to Mg(TFSI)₂ ranging from 1:2 to 2.5:1 exhibit high solution conductivity; all samples being greater than 1 mS/cm at this molarity of magnesium and room temperature. Electrolyte solutions for secondary magnesium batteries, which are the product of magnesium halide (e.g., MgCl₂) and another inorganic salt (e.g., Mg(TFSI)₂) containing an inorganic polyatomic monovalent anion is one preferred embodiment of a complex salt useful in an electrolyte according to principles of the invention. In another preferred embodiment these inorganic Magnesium halide complex solutions display high conductivity of >1 mS/cm at 25 degrees Celsius.

TABLE 4

| Mole Ratio of | |
|---|---|
| MgCl2 to MgTFSI2 | Conductivity |
| 1:4 | 2.90 mS/cm @ 28.0 C. |
| 1:2 | 3.73 mS/cm @ 28.5 C. |
| 2:3 | 4.16 mS/cm @ 28.5 C. |
| 1:1 | 5.04 mS/cm @ 28.0 C. |
| 3:2 | 5.31 mS/cm @ 28.5 C. |
| 2:1 | 5.55 mS/cm @ 28.3 C. |
| 2.5:1 | 5.80 mS/cm @ 28.2 C. |

### Example 7

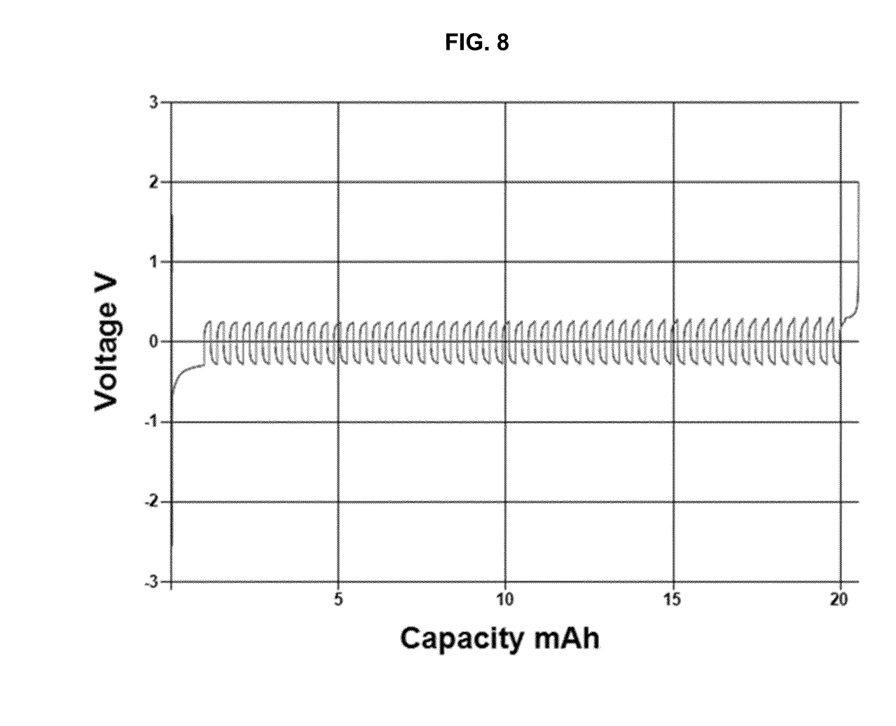

FIG. 8 is a graph displaying a typical macrocoulometry cycling data for the inorganic magnesium salt complex Mg₃Cl₄(TFSI) resulting from reaction of 2MgCl₂ and 1Mg(TFSI)₂ in a mixed solution of 1,2-dimethoxymethane (DME) and N,N-propyl-methyl-pyrrolidinium-bis(trifluoromethylsulfonyl)imide (P13-TFSI) ionic liquid. The two-electrode experiment utilized galvanostatic cycling at 1 mA/cm² to deposit about 2 microns of Magnesium onto a platinum working electrode from an Mg counter electrode. Subsequently 20% of the Mg layer is stripped and re-electrodeposited for 50 cycles prior to stripping the remaining 80% of Mg. The Coulometric efficiency of this process mimics deep cycling in a commercial cell. In FIG. 3 the average Coulometric efficiency over 50 cycles is 98.92%.

Furthermore the cycling occurs with low overpotential to Mg deposition and Mg stripping. The high Coulombic efficiency, high degree of reversibility, and low polarization depicted in FIG. 8 is typical for preferred embodiments of these solutions. According to principles of the invention, inorganic magnesium electrolyte solutions for secondary magnesium batteries with Coulombic efficiency >98%, which are the product of magnesium halide (e.g., MgCl₂) and another inorganic salt (e.g., Mg(TFSI)₂) containing an inorganic polyatomic monovalent anion is one preferred embodiment of a complex salt.

### Example 8

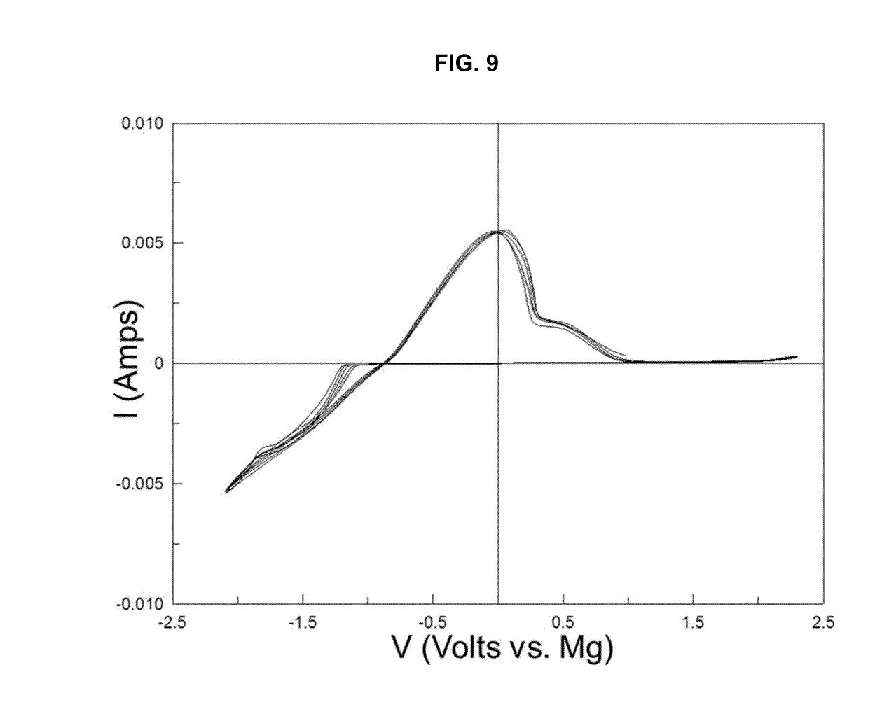

FIG. 9 is a graph displaying a typical cyclic voltammograms of the inorganic magnesium salt complex resulting from reaction of MgCl₂ and Mg(TFSI)₂ when the solvent utilized is a combination of butyl diglyme and the ionic liquid N,N-propyl-methyl-pyrrolidinium-bis(trifluoromethylsulfonyl)imide. The experiment utilized a scan rate of 25 mV/s, a platinum working electrode, and Mg for the counter and reference electrodes. The mole ratio of MgCl₂ to Mg(TFSI)₂ is about 2:1 in this inorganic salt solution. To one practiced in the art, the voltammogram in FIG. 9 shows a high degree of reversibility and Coulombic efficiency, and the Mg deposition and stripping occurs with low overpotential. Such solutions are expected to provide much improved safety over previous organometallic-based Mg electrolytes due to not only the inorganic nature of the salt complex, but also the favorable vapor pressure and flash point of the solvents utilized.

### Example 9

The formation of an electrochemically active Mg₂Cl₃-TFSI solution can be dependent upon ascertaining proper conditions for some or all of the following non-limiting examples of solution variables: the mole ratio of Mg:Cl:TFSI (or other anodically stable anion), overall molarity, solvent properties, precursor and solvent purity, and reaction conditions. In one preferred embodiment, a suitable complex is prepared by reacting MgCl₂ with a compound containing bis(trifluoromethanesulfonyl)imide. In a typical preparation of an electrochemically active Mg₂Cl₃-TFSI solution such as 0.25 M Mg₂Cl₃-TFSI, one may perform the following reaction:

3MgCl₂+1Mg[N(CF₃SO₂)₂]₂→2Mg₂Cl₃[N(CF₃SO₂)₂] Eq. (1)

Place both ˜1.758 g MgCl₂ powder (99.99%) and ˜2.016 g Mg[N(CF₃SO₂)₂]₂ (min. 97%) into a single glass container with a stir bar under inert atmosphere. Thereafter add 30.0 ml of tetrahydrofuran (THF, anhydrous <20 ppm H₂O) and 20.0 ml of 1,2-dimethoxymethane (DME, anhydrous <20 ppm H₂O). Subsequently stir for a time in the range from one to twenty-four hours at a temperature above room temperature after which solution may be returned to room temperature. In some cases it is preferential to heat the sample to 30.0° Celsius or more while stirring in order to facilitate reaction of the materials. The resulting solution is clear or slightly cloudy or translucent with no precipitation. In some embodiments it is preferable to rigorously stir over Mg metal powder in order to condition the solution for improved electrochemical response by reducing residual water and other impurities.

The product can be described as Mg₂Cl₃[N(CF₃SO₂)₂] salt or more generally as a magnesium halide cation complex or more specifically as a Mg₂Cl₃-TFSI complex solution. In some embodiments it may be preferable to note the coordination solvent molecules to the complex cation. The product of this reaction enables reversible, facile electrochemical plating and stripping of Mg ions onto an electrode while maintaining a high anodic stability, and these advantageous electrochemical characteristics are achieved without the use of Grignard reagents, organometallic materials, or Lewis acid derived anions including tetrachloroaluminate or tetraphenylborate.

If X represents a halide, and Z represents an inorganic polyatomic monovalent ion, such as the non-limiting examples of anions listed in Table 3, it is possible to generalize formulas the complexes or compounds that are expected to be useful in electrolytes for secondary Mg batteries, for electrochemical cells having a Mg electrode and in energy storage devices having a Mg electrode. Such generalized formulas are given in Table 5, along with specific examples for different integer values of the variable n.

TABLE 5

| | | | Equivalent | Example in Which |
|---|---|---|---|---|
| | Value | Compound | Cation and | X = Cl and Z = |
| Formula | of n | or Complex | Anion Species | TFSI |
| Mgₙ₊₁X₂ₙZ₂ | 0 | MgZ₂ | Mg²⁺ + 2Z⁻ | Mg²⁺ + |
| | | | | 2(TFSI)⁻ |
| | 1 | Mg₂X₂Z₂ | 2MgX⁺ + 2Z⁻ | 2MgCl⁺ + |
| | | | | 2(TFSI)⁻ |
| | 2 | Mg₃X₄Z₂ | MgX⁺ + | MgCl⁺ + |
| | | | Mg₂X₃⁺ + | Mg₂Cl₃⁺ + |
| | | | 2Z⁻ | 2(TFSI)⁻ |
| | 3 | Mg₄X₆Z₂ | 2Mg₂X₃⁺ + | 2Mg₂Cl₃⁺ + |
| | | | 2Z⁻ | 2(TFSI)⁻ |
| | 4 | Mg₅X₈Z₂ | MgX₂ + | MgCl₂ + |
| | | | 2Mg₂X₃⁺ + | 2Mg₂Cl₃⁺ + |
| | | | 2Z⁻ | 2(TFSI)⁻ |

### Example 10

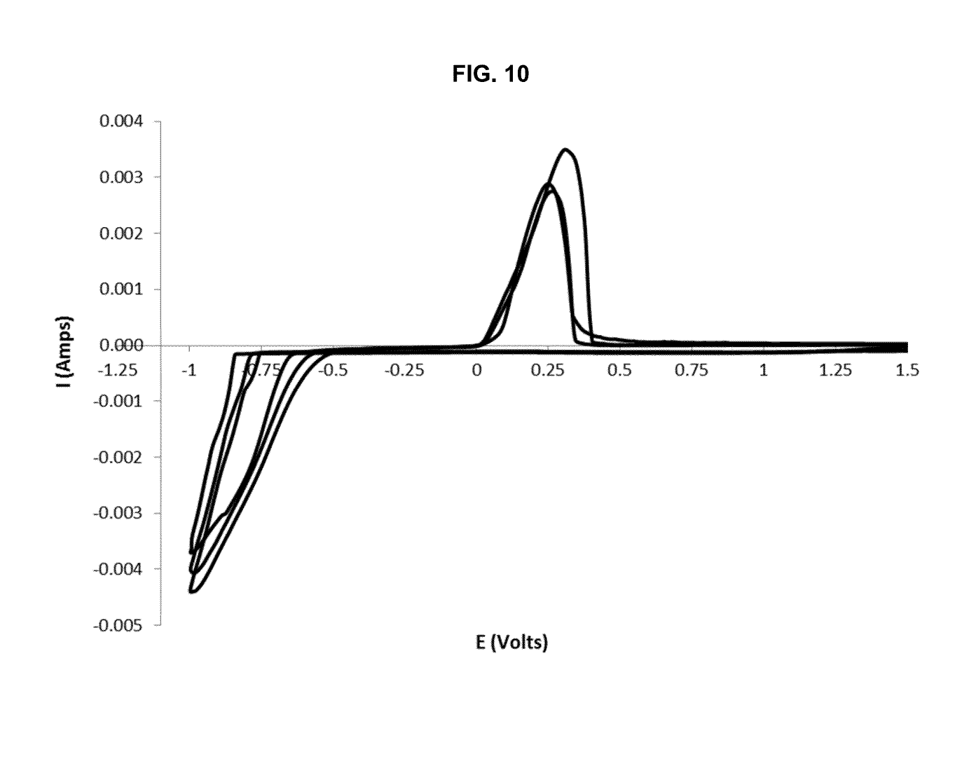

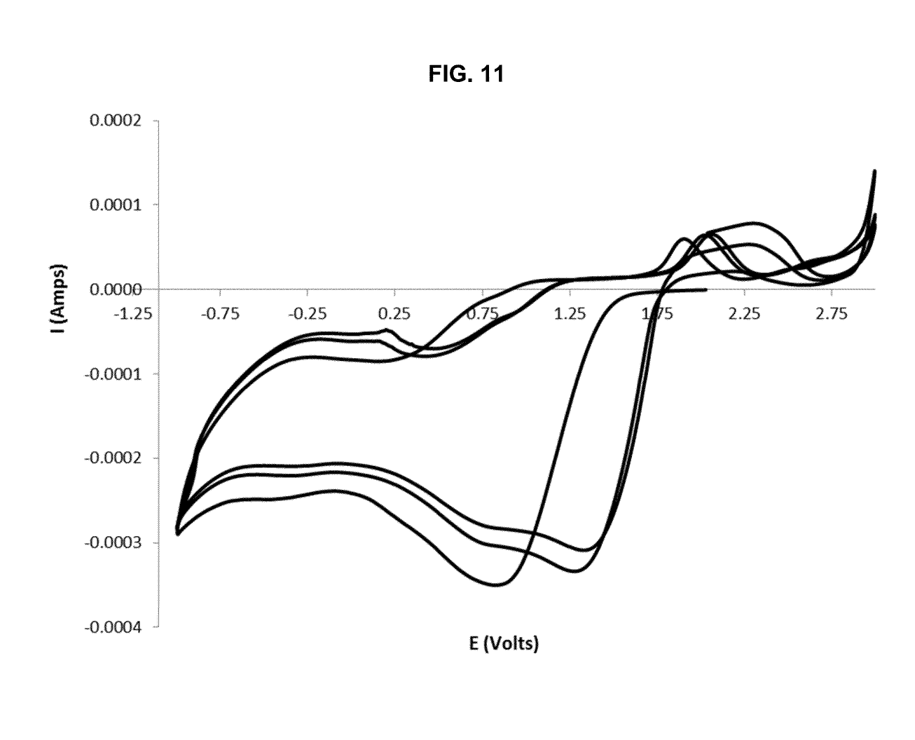

FIG. 10 displays the potentiodynamic behavior of a Mg electrolyte solution containing less than about 110 ppm of water. This graph depicts a typical cyclic voltammogram demonstrating the high degree of Coulombic efficiency and overall high current response associated with the Mg electrodeposition (beginning at −0.5 V vs. Mg) and Mg electrodissolution (beginning at 0 V vs. Mg) in a solution with less than about 200 ppm of total water content. In contrast FIG. 11 displays the potentiodynamic behavior of a Mg electrolyte solution containing about 230 ppm of water. This graph depicts a typical cyclic voltammogram, which demonstrates near complete Coulombic inefficiency of the Mg electrodeposition process (beginning at −0.5 V vs. Mg) and almost negligible current response of the Mg electrodissolution in a solution with greater than about 200 ppm of total water content. These experiments are conducted with an all-inorganic magnesium aluminum chloride complex salt dissolved in a tetrahydrofuran (THF) at room temperature. The scan rate is 25 mV/sec and the working electrode is Pt while Mg metal serves as both the counter and reference electrodes.

### Example 11

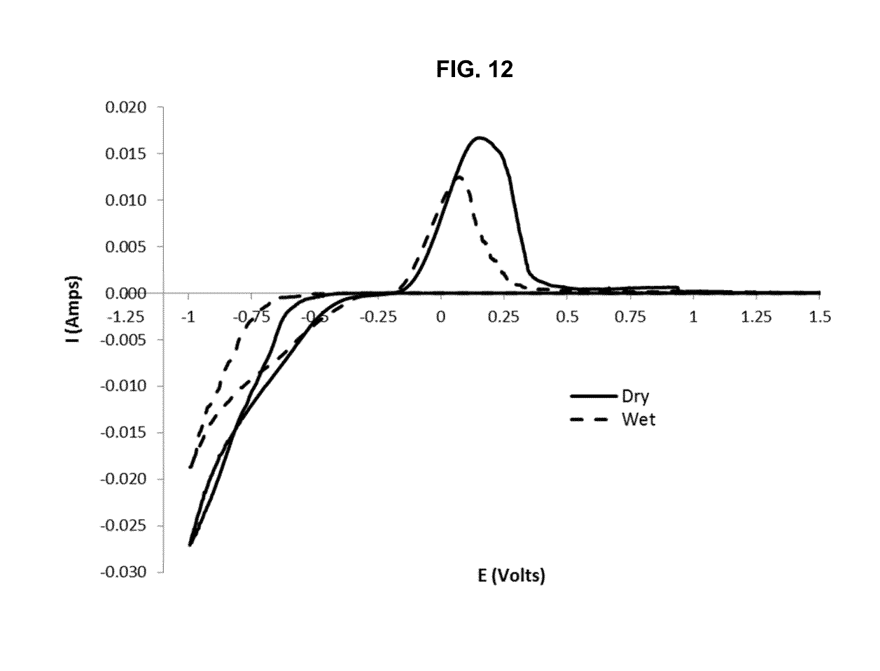

Now referring to FIG. 12, which shows the comparison of typical cyclic voltammograms of an electrolyte with total water content of less than about 50 ppm, identified as “Dry”, as compared to an Mg electrolyte solution with content of greater than about 150 ppm water and identified as “Wet” in FIG. 3. This data shows that even at greater than about 150 ppm total water content the current response begins to diminish. Here the peak reduction current and peak oxidation current are about 25% less Amps than in the “Dry” solution. In addition, the “Wet” solution shows about 150 mV greater overpotential to deposition than the “Dry” solution at corresponding current responses. In a typical electrochemical cell the increased Mg electrodeposition overpotential will translate to decreased energy efficiency of a cell containing the “Wet” electrolyte as compared to a cell containing the “Dry” electrolyte. These experiments are conducted with a non-aqueous Magnesium electrolyte solution containing 0.25 M MgCl₂ and 0.125 M Magnesium bis(trifluoromethylsulfonyl)imid dissolved in a 1,2-dimethoxyethane (DME) at room temperature. The scan rate is 25 mV/sec and the working electrode is Pt while Mg metal serves as both the counter and reference electrodes.

### Example 12

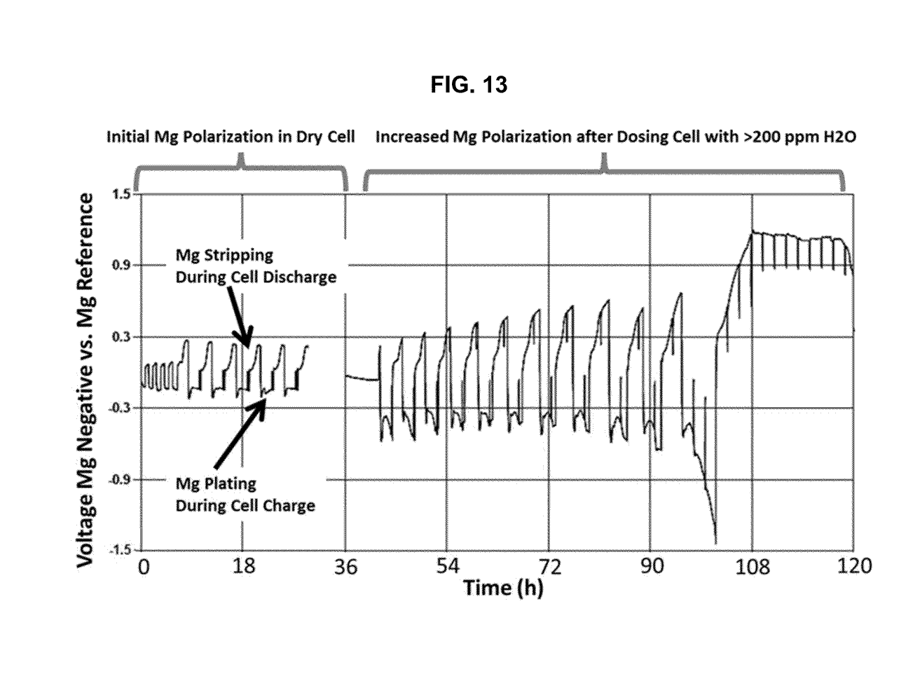

A rechargeable Mg cell was dosed with water in the midst of galvanostatic cycling to confirm the expectation that the upper threshold of tolerable water content in a rechargeable Mg cell electrolyte is about 200 ppm. FIG. 13 depicts the change in polarization of an Mg metal anode (voltage measured against a reference electrode is shown) while galvanostatically cycled against a positive electrode material of a different kind. The potential response after 36 hours (the point at which the dose of water was added) shows significant increase in polarization, or voltage hysteresis, of an Mg metal anode when galvanostatic cycling resumes due to the addition of water to a total content greater than about 200 ppm. It is clear that the Mg anode polarization increases to two to three times that of a cell wherein the total water content of the electrolyte is less than the threshold value of about 200 ppm water.

As demonstrated by the above examples, an Mg electrolyte solution with a total water content of less than about 200 ppm is advantageous to facilitating the electrochemical deposition and dissolution of Mg from the negative electrode without the use of any additive. They are advantageous to rechargeable Mg batteries for both minimization of anode polarization and maximization of Coulombic efficiency. Mg electrolyte solutions containing any amount less than 200 ppm water provide minimal anode polarization and maximum Coulombic efficiency. Incorporation of greater than about 200 ppm water in Mg electrolyte solutions results in increased anode polarization due to partial passivation of the Mg anode as a consequence of parasitic reaction with water that may precipitate reaction products on the surface of the negative electrode. In some Mg electrolyte solutions it is possible to completely passivate the Mg negative electrode with transport blocking films, resulting in termination of Mg cycling ability. The deleterious reaction of water with the surface of the Mg anode combined with the fact that this phenomenon is not limited to a single electrolyte composition merits the adherence of all additive free Mg electrolyte solutions to water levels below 200 ppm.

This requirement is in contradistinction to Li-ion and other monovalent salt battery electrolytes that are capable of providing optimal cycling performance over a wide range of water content from more than zero to less than several hundred to several thousand ppm of water. This disparity is surprising because Li possesses 0.7 V more thermodynamic potential to react with water and is generally kinetically more reactive than Mg. It is anticipated that the lower water tolerance of the Mg electrolyte as compared Li electrolyte arises from the ability of Mg to simultaneously transfer multiple electrons. Therefore it is expected that other multi-valent battery systems (i.e. Al3+, Ca2+, etc.) will experience the same problems and should also be included herein.

According to further features in preferred embodiments described below, the electrolyte is incorporated into specific Mg-ion electrochemical cells comprised of said electrolyte and an appropriate Mg anode and cathode pair. In one aspect an appropriate anode-cathode pair is a magnesium metal anode, or alloy thereof, and a magnesium insertion-compound cathode. In another aspect an appropriate anode-cathode pair is a magnesium metal anode and a cathode capable of conversion, or displacement reactions. In yet another aspect an appropriate anode-cathode pair is a magnesium metal anode and a catholyte.

The significantly higher Coulombic and energy (voltage) efficiency obtained using electrolytes described herein indicates improved stability for the electrolytic solution allowing substantial increases to the Coulombic efficiency, energy efficiency, cycle life, and the energy density of the battery. Furthermore the present invention enables cheaper, safer, and more chemically stable materials to be utilized for these purposes.

In some specific embodiments described herein solutions formed from combinations of Magnesium Chloride (MgCl₂) and other Magnesium salts in ethereal solvents such as THF and Glyme successfully address the shortcomings of the previously reported Mg electrolytes and provide a basis for the production of a viable, rechargeable magnesium battery with anode polarization between plating and stripping is <500 mV or overall cell wherein the energy efficiency is >65%. In other specific embodiments described herein solutions formed from combinations of MgCl₂ and other salts considered Lewis acidic with respect to MgCl₂ in ethereal solvents such as THF and Glyme successfully address the shortcomings of the previously reported Mg electrolytes and provide a basis for the production of a viable, rechargeable magnesium battery with anode polarization between plating and stripping is <500 mV or overall cell wherein the energy efficiency is >65%.

In some specific embodiments described herein solutions formed of Magnesium salts in non-aqueous solvents such as THF and Glyme successfully address the shortcomings of the previously reported Mg electrolytes and provide a basis for the production of a viable, rechargeable magnesium battery with anode polarization between plating and stripping is <500 mV or overall cell wherein the energy efficiency is >65%. In other specific embodiments described herein solutions formed from combinations of a Magnesium halide and other salts in non-aqueous successfully address the shortcomings of the previously reported Mg electrolytes and provide a basis for the production of a viable, rechargeable magnesium battery with anode polarization between plating and stripping is <500 mV or overall cell wherein the energy efficiency is >65%.

In some specific embodiments described herein solutions formed of Magnesium salts in non-aqueous solvents such as THF and Glyme successfully address the shortcomings of the previously reported Mg electrolytes and provide a basis for the production of a viable, rechargeable magnesium battery with anode polarization between plating and stripping is <500 mV or overall cell wherein the energy efficiency is >65%. In other specific embodiments described herein solutions formed from combinations of a Magnesium halide and other salts in non-aqueous successfully address the shortcomings of the previously reported Mg electrolytes and provide a basis for the production of a viable, rechargeable magnesium battery with anode polarization between plating and stripping is <500 mV or overall cell wherein the energy efficiency is >65%.

In another embodiment, the Mg molarity is in the range from 0.1 M to 2 M.

In a further embodiment, the Mg molarity is in the range from 0.25 M to 0.5 M.

In still another embodiment, the solution conductivity is greater than 1 mS/cm at 25 degrees Celsius.

In yet a further embodiment, at least one organic solvent is a solvent selected from the group consisting of an ether, an organic carbonate, a lactone, a ketone, a glyme, a nitrile, an ionic liquid, an aliphatic hydrocarbon solvent, an aromatic hydrocarbon solvent and an organic nitro solvent, and mixtures thereof.

In an additional embodiment, at least one organic solvent is a solvent selected from the group consisting of THF, 2-methyl THF, dimethoxyethane, diglyme, triglyme, tetraglyme, ethyl diglyme, butyl diglyme, diethoxyethane, diethylether, proglyme, dimethylsulfoxide, dimethylsulfite, sulfolane, ethyl methyl sulfone, acetonitrile, hexane, toluene, nitromethane, 1-3 dioxalane, 1-4 dioxane, trimethyl phosphate, tri-ethyl phosphate, hexa-methyl-phosphoramide (HMPA), N,N-propyl-methyl-pyrrolidinium-bis(trifluoromethylsulfonyl)imide (P13-TFSI), N,N-propyl-methyl-pyrrolidinium-diacetamide (P13-DCA), propyl-methyl-pyrrolidinium-bis(fluorosulfonyl)imide (P13-FSI), ethyl-dimethyl-propyl-ammonium-bis(trifluoromethylsulfonyl)imide (PDEA-TFSI), 1-(methoxyethyl)-1-methylpiperidinium-bis(trifluoromethylsulfonyl)imide (MOEMPP-TFSI), and mixtures thereof.

In one more embodiment, at least one organic solvent comprises at least one of THF and dimethoxyethane.

In some embodiments, the electrolyte solution further comprises a polymer or gel in addition to, or as replacement of one or more non-aqueous solvents.

In another embodiment, the Magnesium salt of the electrolyte contains an anion that is at least one of the following non-limiting examples or combinations thereof: chloride, bis(trifluoromethylsulfonyl)imide, triflate, sulfate, bis(oxalate)borate, perchlorate, chlorate, hexafluoroarsenate, trifluoroacetate, hexafluoroantimonate, perfluorobutylsulfonate, Tris(trifluoromethanesulfonyl)methide, heptafluorobutanoate, thiocyanate, tetrachloroaluminate, tetrachloroborate, alkyl or allyl chloroaluminate, alkyl or allyl chloroborate, triflinate.

While not being bound by any particular mode of operation, it is hypothesized that in some embodiments the ionic species in the Mg electrolyte solution will comprise MgCl⁺ and/or Mg₂Cl₃⁺ and/or Mg₃Cl₄⁺ clusters in solution. Polyatomic cationic species comprising other Mg halides, such as MgBr⁺ and/or Mg₂Br₃⁺ clusters, and MgF⁺ and/or Mg₂F₃⁺ clusters may also be suitable for reversible Mg deposition in Mg electrolyte solutions requiring less than about 200 ppm total water content.

According to another aspect, the invention relates to a rechargeable magnesium battery having a non-aqueous Mg electrolyte solution with a total water content of <200 ppm. The rechargeable magnesium battery having a non-aqueous electrolyte solution comprises at least one organic solvent, and a magnesium salt. As used herein, the terms battery, cell, and electrochemical cell are used interchangeably to describe the combination of a positive electrode, a negative electrode, and a non-aqueous Mg electrolyte comprising one or more Mg salts in one or more non-aqueous solvents and a total water content of <200 ppm that allows for highly reversible electrodeposition and stripping of Mg from the negative electrode.

In another aspect, the invention relates to a rechargeable magnesium battery having a non-aqueous Mg electrolyte solution comprising at least one organic solvent, at least one magnesium salt, and a total water content of <200 ppm, and displaying high Coulombic efficiency and energy efficiency.

In yet another aspect, the invention relates to a rechargeable magnesium battery having a non-aqueous Mg electrolyte solution comprising at least one organic solvent, at least one magnesium salt, and a total water content of <200 ppm, and displaying Coulombic efficiency >98%, and energy efficiency >65%.

In another aspect, the invention relates to a cell containing a Mg metal, or alloy, electrode in contact with a non-aqueous Mg electrolyte solution comprising at least one organic solvent, at least one magnesium salt, and a total water content of <200 ppm, and displaying high Coulombic efficiency and low anode polarization measured between the electrodeposition and stripping of the Mg metal, or alloy, electrode and said electrolyte.

In yet another aspect, the invention relates to a cell containing a Mg metal, or alloy, electrode in contact with a non-aqueous Mg electrolyte solution comprising at least one organic solvent, at least one magnesium salt, and a total water content of <200 ppm, and displaying Coulombic efficiency >98%, and <500 mV anode polarization measured between the electrodeposition and stripping of the Mg metal, or alloy, electrode and said electrolyte.

In one embodiment, the magnesium anode is selected from the group consisting of Mg metal, Anatase TiO₂, rutile TiO₂, Mo₆S₈, FeS₂, TiS₂, and MoS₂.

In another embodiment, the Mg metal is an alloy.

In yet another embodiment, the Mg alloy selected from the group of Mg alloys consisting of AZ31, AZ61, AZ63, AZ80, AZ81, AZ91, AM50, AM60, Elektron 675, ZK51, ZK60, ZK61, ZC63, MIA, ZC71, Elektron 21, Elektron 675, Elektron, and Magnox.

In some embodiments, the negative electrode layer further comprises an electronically conductive additive. Non-limiting examples of electronically conductive additives include carbon black, Super P, Super C65, Ensaco black, Ketjen black, acetylene black, synthetic graphite such as Timrex SFG-6, Timrex SFG-15, Timrex SFG-44, Timrex KS-6, Timrex KS-15, Timrex KS-44, natural flake graphite, carbon nanotubes, fullerenes, hard carbon, or mesocarbon microbeads.

In some embodiments, the negative electrode layer further comprises a polymer binder. Non-limiting examples of polymer binders include poly-vinylidene fluoride (PVdF), poly(vinylidene fluoride-co-hexafluoropropene) (PVdF-HFP), Polytetrafluoroethylene (PTFE), Kynar Flex 2801, Kynar Powerflex LBG, and Kynar HSV 900, Styrene-Butadiene Rubber (SBR), carboxymethyl cellulose (CMC), sodium alginate, or Teflon.

In yet another embodiment, the magnesium cathode is selected from the group consisting of Chevrel phase Mo₆S₈, MnO₂, CuS, Cu₂S, Ag₂S, CrS₂, VOPO₄, a layered structure compound, a spinel structured compound, a zinc blende structure, a rock salt structured compound, a metal chloride, a NASICON structured compound, a Cadmium iodide structured compound, an Olivine structured compound, a Tavorite structured compound, a pyrophosphate, a monoclinic structured compound, and a fluoride.

In still another embodiment, the layered structure compound is selected from the group consisting of TiS₂, V₂O₅, MgVO₃, MoS₂, MgV₂O₅, and MoO₃.

In a further embodiment, the spinel structured compound is selected from the group consisting of CuCr₂S₄, MgCr₂S₄, MgMn₂O₄, MgNiMnO₄, and Mg₂MnO₄.

In yet a further embodiment, the NASICON structured compound is selected from the group consisting of MgFe₂(PO₄)₃ and MgV₂(PO₄)₃.

In an additional embodiment, the Olivine structured compound is selected from the group consisting of MgMnSiO₄ and MgFe₂(PO₄)₂.

In one more embodiment, the Tavorite structured compound is Mg_{0.5}VPO₄F.

In still a further embodiment, the pyrophosphate is selected from the group consisting of TiP₂O₇ and VP₂O₇.

In another embodiment, the fluoride is selected from the group consisting of MgMnF₄ and FeF₃.

In some embodiments, the positive electrode layer further comprises an electronically conductive additive. Non-limiting examples of electronically conductive additives include carbon black, Super P, Super C65, Ensaco black, Ketjen black, acetylene black, synthetic graphite such as Timrex SFG-6, Timrex SFG-15, Timrex SFG-44, Timrex KS-6, Timrex KS-15, Timrex KS-44, natural flake graphite, carbon nanotubes, fullerenes, hard carbon, or mesocarbon microbeads.

In some embodiments, the positive electrode layer further comprises a polymer binder. Non-limiting examples of polymer binders include poly-vinylidene fluoride (PVdF), poly(vinylidene fluoride-co-hexafluoropropene) (PVdF-HFP), Polytetrafluoroethylene (PTFE), Kynar Flex 2801, Kynar Powerflex LBG, and Kynar HSV 900, Styrene-Butadiene Rubber (SBR), carboxymethyl cellulose (CMC), sodium alginate, or Teflon.

In some embodiments, the Mg battery used in conjunction with the electrolyte described herein comprises a positive electrode current collector comprising carbonaceous material, or a current collector comprising a metal substrate coated with an over-layer to prevent corrosion in the electrolyte. In some embodiments, the Mg battery described herein comprises a negative electrode current collector comprising carbonaceous material, or a current collector comprising a metal substrate coated with an over-layer to prevent corrosion in the electrolyte. In other embodiments, the Mg battery described herein comprises positive and negative electrode current collectors comprising carbonaceous material.

In some embodiments, the Mg battery disclosed herein is a button or coin cell battery comprising a stack of negative electrode, porous polypropylene or glass fiber separator, and positive electrode disks sit in a can base onto which the can lid is crimped. In other embodiments, the Mg battery used in conjunction with the electrolyte disclosed herein is a stacked cell battery. In other embodiments, the Mg battery disclosed herein is a prismatic, or pouch, cell comprising one or more stacks of negative electrode, porous polypropylene or glass fiber separator, and positive electrode sandwiched between current collectors wherein one or both current collectors comprise carbonaceous materials, or a metal substrate coated with an over-layer to prevent corrosion in the electrolyte. The stack(s) are folded within a polymer coated aluminum foil pouch, vacuum and heat dried, filled with electrolyte, and vacuum and heat sealed. In other embodiments, the Mg battery disclosed herein is a prismatic, or pouch, bi-cell comprising one or more stacks of a positive electrode which is coated with active material on both sides and wrapped in porous polypropylene or glass fiber separator, and a negative electrode folded around the positive electrode wherein one or both current collectors comprise carbonaceous materials. The stack(s) are folded within a polymer coated aluminum foil pouch, dried under heat and/or vacuum, filled with electrolyte, and vacuum and heat sealed. In some embodiments of the prismatic or pouch cells used in conjunction with the electrolyte described herein, an additional tab composed of a metal foil or carbonaceous material of the same kind as current collectors described herein, is affixed to the current collector by laser or ultrasonic welding, adhesive, or mechanical contact, in order to connect the electrodes to the device outside the packaging.

In other embodiments, the Mg battery used in conjunction with the electrolyte disclosed herein is a wound or cylindrical cell comprising wound layers of one or more stacks of a positive electrode which is coated with active material on one or both sides, sandwiched between layers of porous polypropylene or glass fiber separator, and a negative electrode wherein one or both current collectors comprise carbonaceous materials. The stack(s) are wound into cylindrical roll, inserted into the can, dried under heat and/or vacuum, filled with electrolyte, and vacuum and welded shut. In some embodiments of the cylindrical cells described herein, an additional tab composed of a metal foil or carbonaceous material of the same kind as current collectors described herein, is affixed to the current collector by laser or ultrasonic welding, adhesive, or mechanical contact, in order to connect the electrodes to the device outside the packaging.

The above descriptions are intended only to serve as examples, and that many other embodiments are possible within the spirit and the scope of the present invention.

### Trace Amount

Depending on the analytical technique used, the term “trace” or “trace amount” as applied to a substance is understood to denote an amount of that substance that is equal to or slightly greater than the amount required to be present in a sample to be detected by the analytical technique. In the absence of a defined limit of detectability, the term “trace” or “trace amount” is understood to signify an amount of less than 200 parts per million.

### THEORETICAL DISCUSSION

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A rechargeable magnesium battery having an additive free non-aqueous electrolyte solution, comprising:
an anode electrode, a cathode electrode, and said non-aqueous electrolyte solution in contact with the anode electrode and the cathode electrode, said non-aqueous electrolyte solution comprising:
at least one organic solvent;
at least one electrolytically active, soluble, Magnesium (Mg) salt; and
water in less than a trace amount.

2. The rechargeable magnesium battery having an additive free non-aqueous electrolyte solution of claim 1, wherein said water is present in an amount less than 200 ppm.

3. The rechargeable magnesium battery having an additive free non-aqueous electrolyte solution of claim 1, wherein an anode polarization between electrodeposition and electrodissolution is less than 500 mV at 25 degrees Celsius.

4. The rechargeable magnesium battery having an additive free non-aqueous electrolyte solution of claim 1, wherein an anode Coulombic efficiency is greater than 98% at 25 degrees Celsius.

5. The rechargeable magnesium battery having an additive free non-aqueous electrolyte solution of claim 1, wherein a cell Coulombic efficiency is greater than 98% at 25 degrees Celsius.

6. The rechargeable magnesium battery having an additive free non-aqueous electrolyte solution of claim 1, wherein the electrolyte solution comprises one or more polymers or gels.

7. The rechargeable magnesium battery having an additive free non-aqueous electrolyte solution of claim 1, wherein said at least one electrolytically active, soluble, Magnesium (Mg) salt is a Magnesium (Mg) halide salt.

8. The rechargeable magnesium battery having an additive free non-aqueous electrolyte solution of claim 7, wherein said trace amount of water is present in an amount less than 200 ppm.

9. The rechargeable magnesium battery having an additive free non-aqueous electrolyte solution of claim 7, wherein an anode polarization between electrodeposition and electrodissolution is less than 500 mV at 25 degrees Celsius.

10. The rechargeable magnesium battery having an additive free non-aqueous electrolyte solution of claim 7, wherein the anode Coulombic efficiency is greater than 98% at 25 degrees Celsius.

11. The rechargeable magnesium battery having an additive free non-aqueous electrolyte solution of claim 7, wherein the cell Coulombic efficiency is greater than 98% at 25 degrees Celsius.

12. The rechargeable magnesium battery having an additive free non-aqueous electrolyte solution of claim 7, wherein the electrolyte solvent comprises one or more polymers or gels.

13. The rechargeable magnesium battery having an additive free non-aqueous electrolyte solution of claim 1, wherein said at least one electrolytically active, soluble, Magnesium (Mg) salt is a Magnesium (Mg) halide complex cation charge balanced by a polyatomic anion.

14. The rechargeable magnesium battery having an additive free non-aqueous electrolyte solution of claim 13 wherein a trace amount of water is present in an amount less than 200 ppm.

15. The rechargeable magnesium battery having an additive free non-aqueous electrolyte solution of claim 13, wherein the anode polarization between electrodeposition and electrodissolution is less than 500 mV at 25 degrees Celsius.

16. The rechargeable magnesium battery having an additive free non-aqueous electrolyte solution of claim 13, wherein the anode Coulombic efficiency is greater than 98% at 25 degrees Celsius.

17. The rechargeable magnesium battery having an additive free non-aqueous electrolyte solution of claim 13, wherein the cell Coulombic efficiency is greater than 98% at 25 degrees Celsius.

18. The rechargeable magnesium battery having an additive free non-aqueous electrolyte solution of claim 13, wherein the electrolyte solvent comprises one or more polymers or gels.

19. A rechargeable multi-valent ion battery having an additive free non-aqueous electrolyte solution, comprising:
an anode electrode, a cathode electrode, and said non-aqueous electrolyte solution in contact with the anode electrode and the cathode electrode, said non-aqueous electrolyte solution comprising:
at least one organic solvent;
at least one electrolytically active, soluble, multi-valent salt; and
water inless than a trace amount.

20. The rechargeable multi-valent battery having an additive free non-aqueous electrolyte solution of claim 19, wherein said water is present in an amount less than 200 ppm.

21. The rechargeable multi-valent ion battery having an additive free non-aqueous electrolyte solution of claim 19, wherein the anode polarization between electrodeposition and electrodissolution is less than 500 mV at 25 degrees Celsius.

22. The rechargeable multi-valent ion battery having an additive free non-aqueous electrolyte solution of claim 19, wherein the anode Coulombic efficiency is greater than 98% at 25 degrees Celsius.

23. The rechargeable multi-valent ion battery having an additive free non-aqueous electrolyte solution of claim 19, wherein the cell Coulombic efficiency is greater than 98% at 25 degrees Celsius.

24. The rechargeable multi-valent ion battery having an additive free non-aqueous electrolyte solution of claim 19, wherein the electrolyte solvent comprises one or more polymers or gels.

25. The rechargeable multi-valent ion battery having an additive free non-aqueous electrolyte solution of claim 19, wherein said at least one electrolytically active, soluble, multi-valent salt is a salt of an element selected from the group consisting of Ca, Al, Zn, and Y.
